(19) United States
(12) Patent Application Publication
(10) Pub. No.: US 2024/0371185 A1
(43) Pub. Date: Nov. 7, 2024

(54) METHODS AND SYSTEMS FOR AUTOMATED REALISTIC VIDEO IMAGE MODIFICATION

(71) Applicants: Rida Sadek, Barcelona (ES); Juan Francisco Garamendi, Fuenlabrada (ES); Vadim Fedorov, Barcelona (ES)

(72) Inventors: Rida Sadek, Barcelona (ES); Juan Francisco Garamendi, Fuenlabrada (ES); Vadim Fedorov, Barcelona (ES)

(21) Appl. No.: 16/886,761

(22) Filed: May 28, 2020

Related U.S. Application Data
(60) Provisional application No. 62/853,325, filed on May 28, 2019.
(60) Provisional application No. 62/853,342, filed on May 28, 2019.

(51) Int. Cl. G06V 20/70; G06T 5/73; G06T 7/194; G06T 7/90; G06T 11/00; G06V 10/74; G06V 20/40

(52) U.S. Cl. CPC G06V 20/70; G06T 5/73; G06T 7/194; G06T 7/90; G06T 11/001; G06V 10/761; G06V 20/41; G06V 20/46; G06T 2207/10016; G06T 2207/30208

(57) ABSTRACT

An automated method and system for generating modified digital video data finds locations of a visual marker image in a source video frame sequence and maps the location of the marker image in the frame sequence to create a tracking layer comprising data that tracks the location of the marker image in the source frame sequence. The tracking layer data maps the location of the marker image relative to the location of the marker image in a keyframe of the source video, the keyframe being a frame in which the match between the marker image and source video location has been detected with a relatively high confidence. An occlusion layer comprising alpha layer data can be created from the source video, the marker image, and the tracking layer to address frames in which features matching the marker image are occluded by foreground elements in the source video. The resulting layer information can be packaged into a file that can be used to replace the visual marker image with new visual content to create the modified digital video.

### CROSS REFERENCE TO RELATED APPLICATIONS

This application claims benefit of U.S. Provisional Patent Application Ser. No. 62/853,325, filed 28 May 2019, and U.S. Provisional Patent Application Ser. No. 62/853,342, filed 28 May 2019, which are incorporated by reference herein.

### BACKGROUND

Embodiments of the inventions relate to systems and methods for automated digital video analysis and editing. This analysis and editing can comprise methods and computer-implemented systems that automate the modification or replacement of visual content in some or all frames of a source digital video frame sequence in a manner that produces realistic high-quality modified video output.

One objective is to improve a video modification process that previously performed manually, and therefore too expensive to be done on a large scale, to a process that can be performed programmatically and/or systematically with minimal or no human intervention. Moving pictures in general, and digital videos in particular, comprise sequences of still images, typically called frames. The action in consecutive frames of a digital video scene is related, a property called temporal consistency. It is desirable to edit the common content of such a frame sequence once, and apply this edit to all frames in the sequence automatically, instead of having to edit each frame manually and/or individually.

Another objective is that the visual results of the video modification process must look natural and realistic, as if the modifications were in the scene at the moment of filming. For example, if new content is embedded to replace a painting:
(a) the new content should move properly with the motion of the camera;
(b) when someone or something passes in front, the new embedded content should be properly occluded;
(c) original shadows should be cast over the embedded content;
(d) changes in ambient lightning conditions should be applied to the new content; and
(e) blur levels due to the camera settings or motion should be estimated and applied to the embedded content.

The operations described in the preceding example are necessary to make the newly embedded digital content an integral part of a video file for a depicted scene. To that end, the desired programmatic video editing process is clearly different than simple operations such as merging of two video files, cutting and remuxing (re-multiplexing) of a video, drawing of an overlay on top of a video content, etc.

To accomplish the objectives identified above, the content in a video frame can be separated into foreground objects and background content. Parts of the background content may be visible in some frames of the sequence and occluded by the foreground objects in other frames of the sequence. To correctly and automatically merge the background content of such a sequence with foreground objects after editing, it is necessary to determine if a pixel belonging to the background content is occluded in a particular frame by a foreground object. If a foreground object moves relative to the background, the location of the background pixels that are occluded will change from frame to frame. Thus, the pixels in the background content must be classified as being occluded or non-occluded in a particular video frame and it is desired that this classification be performed automatically. Automated binary decomposition (classification) of background pixels into occluded or non-occluded classes is useful because it facilitates the automated replacement of part or all of the old background content new background content in the digital video frame sequence. For example, such classification allows the addition of an advertisement on a wall that is part of the background content behind a foreground person walking in the frame sequence.

Due to the discrete pixelized nature of a digital image recording, the pixels located at the external boundaries of the foreground object(s) in an original unmodified digital video frame are initially recorded as a mixture of information from a foreground object and the background content. This creates smooth natural contours around the foreground object in the original digital video recording. If this mixing of information was not done for these transition pixels, the foreground object would look more jagged and the scene would look less natural. Compositions created by video editing methods and systems that use only a binary classification of boundary pixels (occluded/not occluded) look obviously edited, unnatural, and/or unrealistic. It is desired to effectively use these techniques to automatically produce a realistic edited video scene.

### BRIEF DESCRIPTION OF THE DRAWINGS

For a more complete understanding of the present invention and the advantages thereof, reference is made to the following description taken in conjunction with the accompanying drawings in which like reference numerals indicate like features and wherein;

FIG. 1 is an overview a fully-automated workflow for delivering dynamic video content;

FIG. 2 shows a visual overview of the workflow of FIG. 1 by illustrating a digital video frame sequence in which a part of the background content defined by a visual marker is replaced with new visual content without changing the active foreground of the sequence;

FIG. 3 details the steps of the video analysis process of FIG. 1 and FIG. 2;

FIG. 4 details a first part (visual marker analysis) of the video analysis process of FIG. 3;

FIG. 5A shows a processing example of the marker detection process of FIG. 3;

FIG. 5B illustrates a more complex image transformation than the example in FIG. 5A;

FIG. 6 shows the projective transformation of the marker of FIG. 5A and FIG. 5B when it is propagated through of a time-sequenced set of video frames;

FIG. 7 is a second part (video info extraction) of the video analysis process of FIG. 3;

FIG. 8 is a third part (blueprint preparation) of the video analysis process of FIG. 3;

FIG. 9 shows the main data structures for the workflow of FIG. 1 and FIG. 2;

FIG. 10A and FIG. 10B depict an encoding process that takes corresponding layers and serializes them into a series of data entries;

FIG. 11 details the steps of the video generation process of FIG. 1;

FIG. 12 shows a detail of set of the pixels located at the external boundaries of a foreground object in an original unmodified digital video frame, in this case an occluded computer screen in the background behind a man in the foreground;

FIG. 13 shows an example of a frame sequence with a static background, foreground action, and no camera movement;

FIG. 14 shows an example of a frame sequence with a static background, foreground action, and camera movement;

FIG. 15 shows the result of applying a direct transformation to a reference frame to correct for the camera movement of the frame sequence in FIG. 14;

FIG. 16 shows the result of applying an inverse transformation to each frame in the sequence of FIG. 14 to correct for camera movement;

FIG. 17 shows a region of a video frame in which the pixels will be classified as being occluded, non-occluded, and partially occluded;

FIG. 18 shows occlusions over a static background in the video of FIG. 13 in the white region of FIG. 17;

FIG. 19 shows details of the occlusions in FIG. 12 and in frame 3 of FIG. 13 in which white means occluding pixels, black means non-occluding pixels, and the shades of gray represent the amount of occlusion of the partially occluding pixels;

FIG. 20 is an example of a frame sequence with a static background, foreground action, camera movement, and a global illumination change;

FIG. 21 is an example of how the illumination change of FIG. 20 can be modeled;

FIG. 22 is an example of a mathematical function representing pure white, blue, and green colors;

FIG. 23 shows an embodiment of the invention that illustrates how a reference frame, an occlusion region, a set of transformations, and a color change function can be used to obtain an occlusion function and a color function for making a transformation to a frame sequence;

FIG. 24 shows an in-video occlusion detection and foreground color estimation method;

FIG. 25 shows a block diagram that describes the box classifier in FIG. 24;

FIG. 26 provides a block diagram of a compare procedure of FIG. 25;

FIG. 27 provides a block diagram of an alternative box compare procedure of FIG. 25 that gets the occlusions and further comprises a refinement step;

FIG. 28 provides detail of the name of each region of a section of a video frame; and

FIG. 29 shows a block diagram of the steps for getting the pure foreground color in areas that are partially occluded.

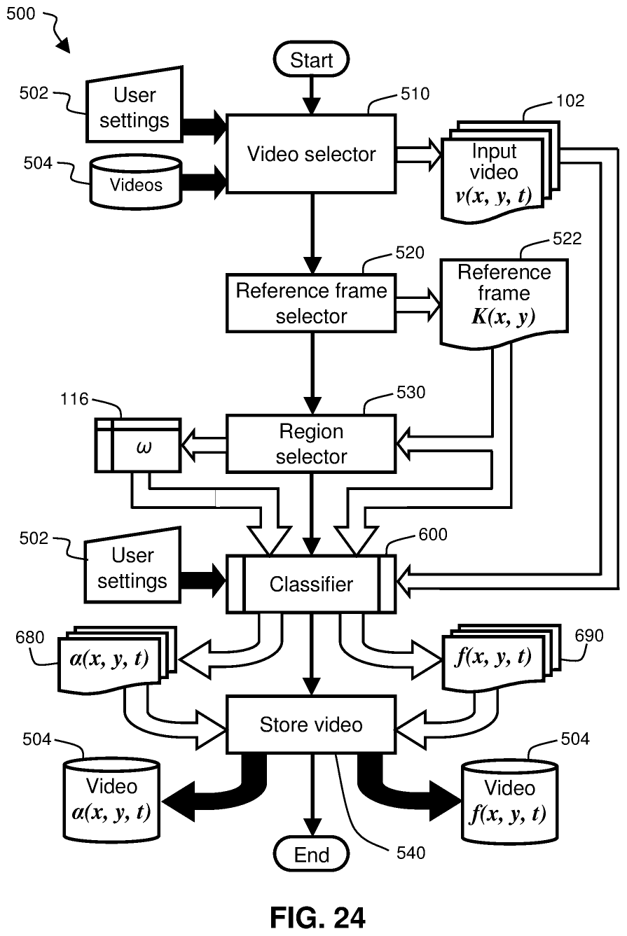

With reference to FIG. 24 to FIG. 27 and FIG. 29, the thin black arrows represent execution flow and the thick arrows (black and white) represent data flow.

It should be understood that the drawings are not necessarily to scale. In certain instances, details that are not necessary for an understanding of the invention or that render other details difficult to perceive may have been omitted. It should be understood that the invention is not necessarily limited to the particular embodiments illustrated herein.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment.

It should be understood that various changes could be made in the function and arrangement of elements without departing from the spirit and scope as set forth in the appended claims. Preferred embodiments of the present invention are illustrated in the Figures, with like numerals being used to refer to like and corresponding parts of the various drawings. Specific details are given in the following description to provide a thorough understanding of the embodiments. However, it will be understood by one of ordinary skill in the art that the embodiments may be practiced without these specific details.

### 1. GENERAL DEFINITIONS

The definitions that follow apply to the terminology used in describing the content and embodiments in this disclosure and the related claims.

In the current context “dynamic” means that selected visual elements within a video can be modified programmatically and automatically, producing a new variant of that video.

A visual element can be any textured region, for instance, a poster or a painting on a wall, a wall itself, a commercial banner, etc.

### 2. OVERVIEW OF EMBODIMENTS OF THE METHOD AND SYSTEM

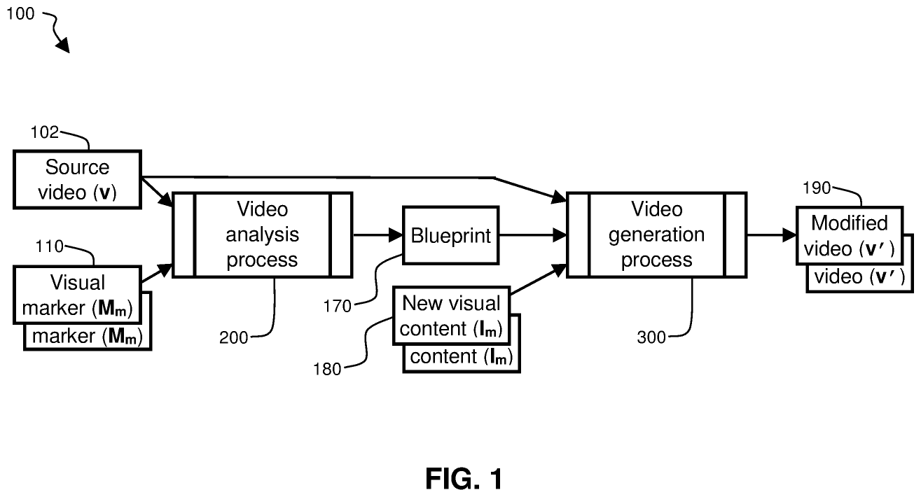

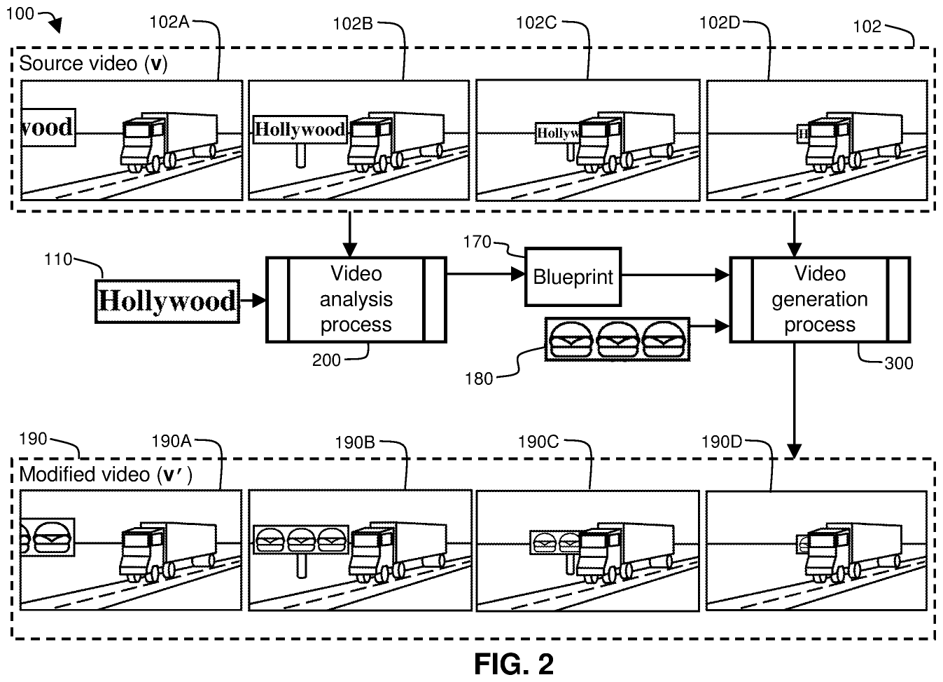

In one embodiment, shown in FIG. 1 and FIG. 2, a fully-automated workflow is used to deliver programmatically modified video content. The fully-automated workflow 100 starts with a source video (i.e. input video) 102 and produces one (or more) modified video(s) 190 with new visual content 180 integrated into the modified video(s) 190. The source video 102 comprises a sequence of video frames, such as the example images shown at 102A, 102B, 102C, and 102D in FIG. 2. The modified video (i.e. output video) 190 comprises a sequence of video frames, at least some of which have been partially modified, as shown by the example images at 190A, 190B, 190C, and 190D.

The workflow, shown in FIG. 1 and FIG. 2, comprises a video analysis process 200, and a video generation process 300. In the video analysis process 200 the source video 102 is analyzed and information about selected regions of interest is collected and packaged into a blueprint 170. Regions of interest can be selected by specifying one (or more) visual marker(s) 110 to be matched with regions in frames of the source video 102. In the video generation process 300, the blueprint 170 can be used to the embed new visual content 180 into the input source video frame sequence 102 to render the modified video frame sequence 190.

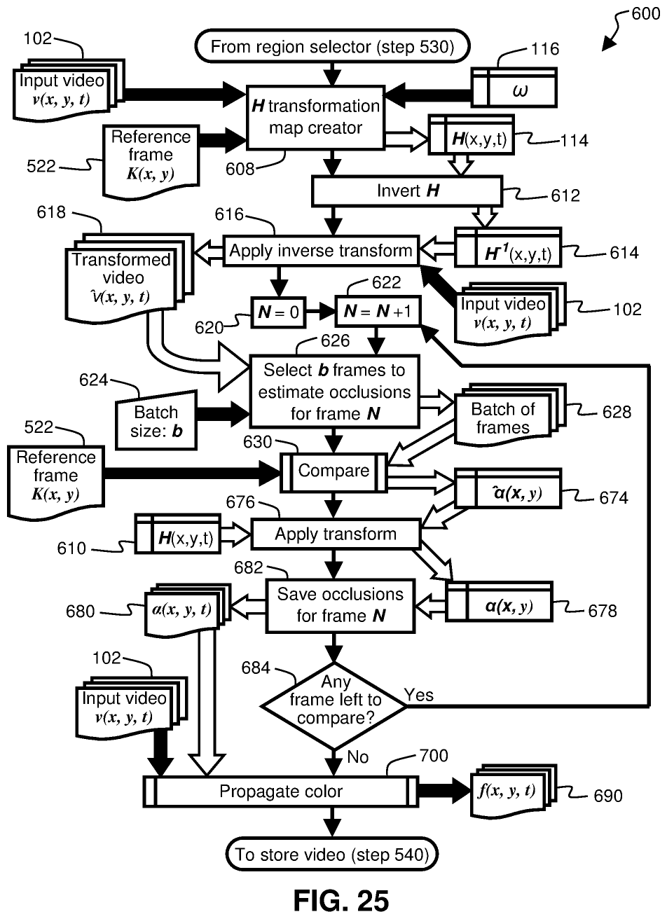

Occlusion detection and processing can be an important element of a workflow that deliver programmatically modified video content. For example, FIG. 2 shows a video frame sequence in which a part of the background content of the frame sequence has been replaced without changing the active foreground object in the sequence. To produce high quality video output, FIG. 24 and FIG. 25 illustrate how embodiments of the present invention can:
(a) receive an input video stream comprising a finite number of frames;
(b) select a reference frame (also called a keyframe) of the input video stream;
(c) select a region of the reference frame;
(d) find regions in at least some of the other frames in the video stream that pixel-wise match the selected reference frame region, according to some metric;
(e) classify pixels inside the regions of the video frames as occluded, nonoccluded or partially-occluded with respect to the reference frame using some criteria such as the difference of a color value between the video frames and the reference frame;
(f) estimate a color value for each pixel classified as belonging to a partially-occluded class; and
(g) determine the percentage of the contribution of the estimated color to the color presented at each pixel belonging to the partially-occluded class.

Embodiments of the method and/or computer-implemented system can comprise a step or element that compares the pixels of a video frame with matching pixels of a reference frame. The method and/or computer-implemented system can comprise neural elements trained with known examples used to determine if a pixel is occluded, non-occluded, or partially-occluded. The method and/or computer-implemented system can give an estimation of the amount of occlusion for each pixel. The method and/or computer-implemented system can also comprise a foreground estimator that determines the occluding color.

### 3. DESCRIPTION OF AUTOMATED WORKFLOW TO DELIVER MODIFIED VIDEO CONTENT

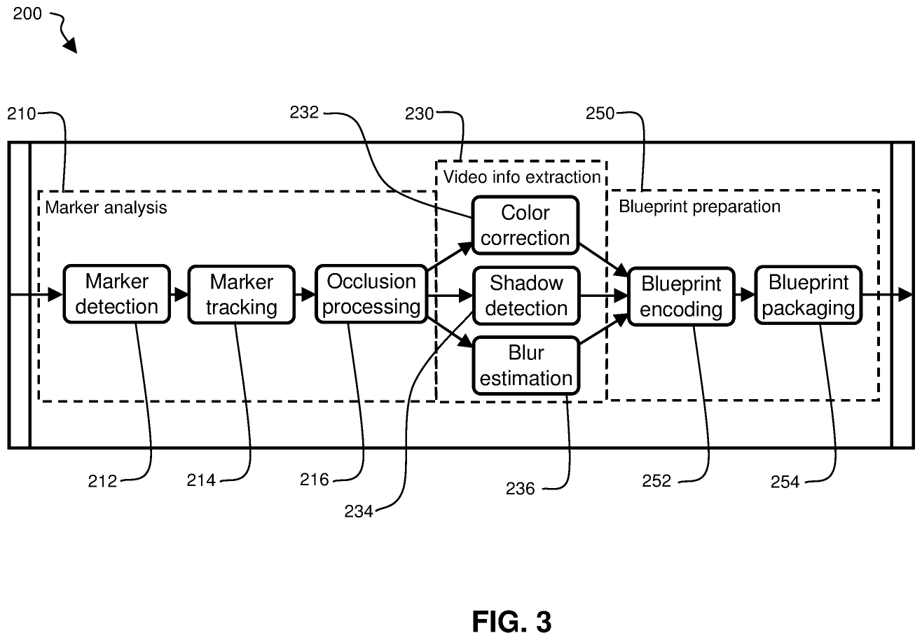

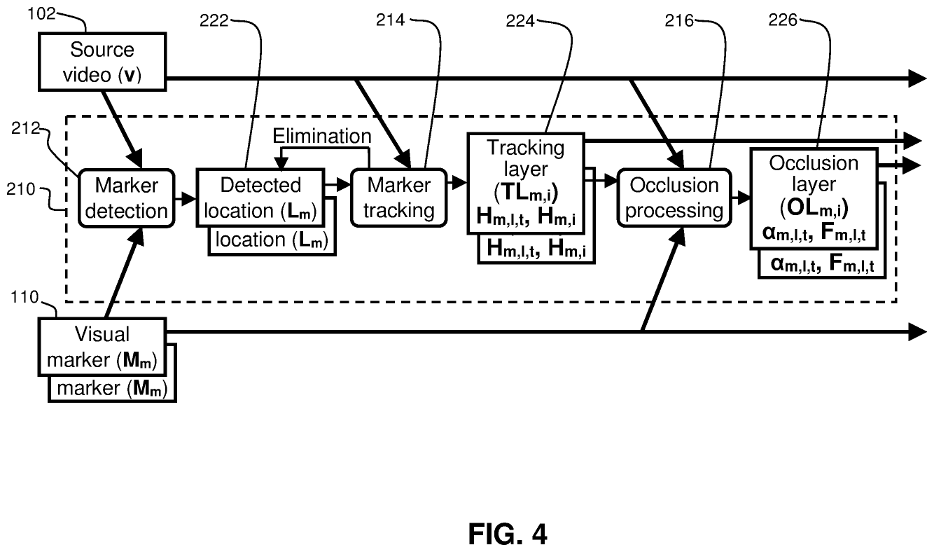

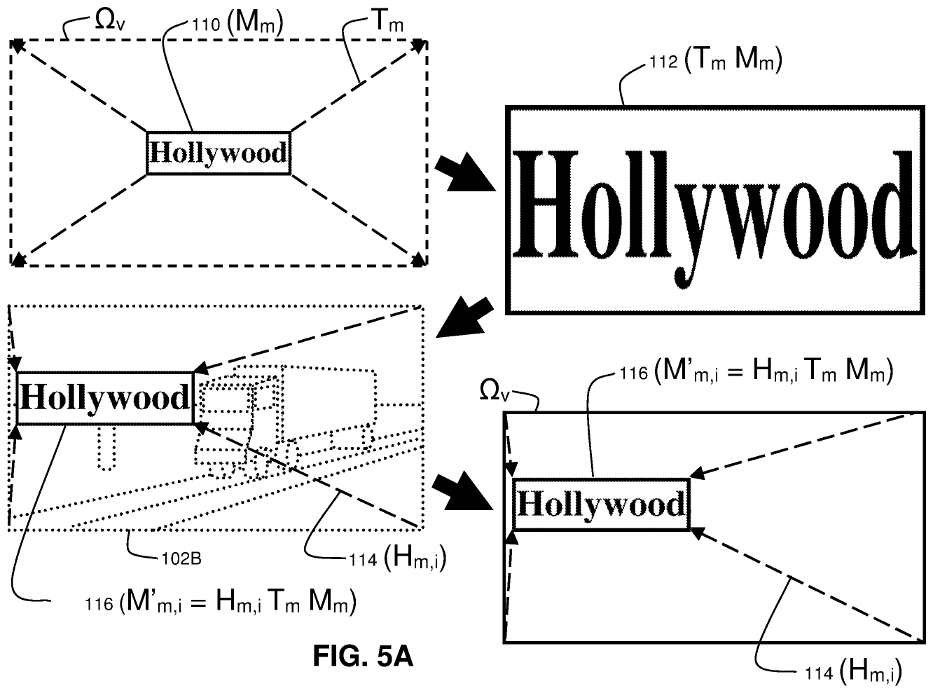

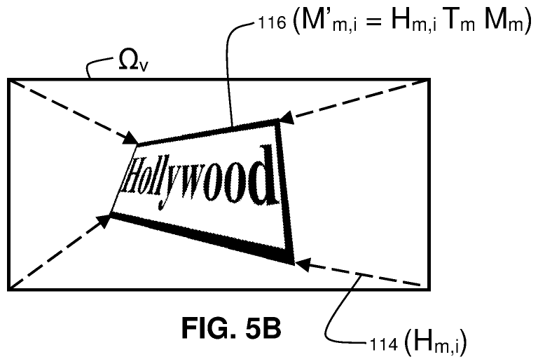

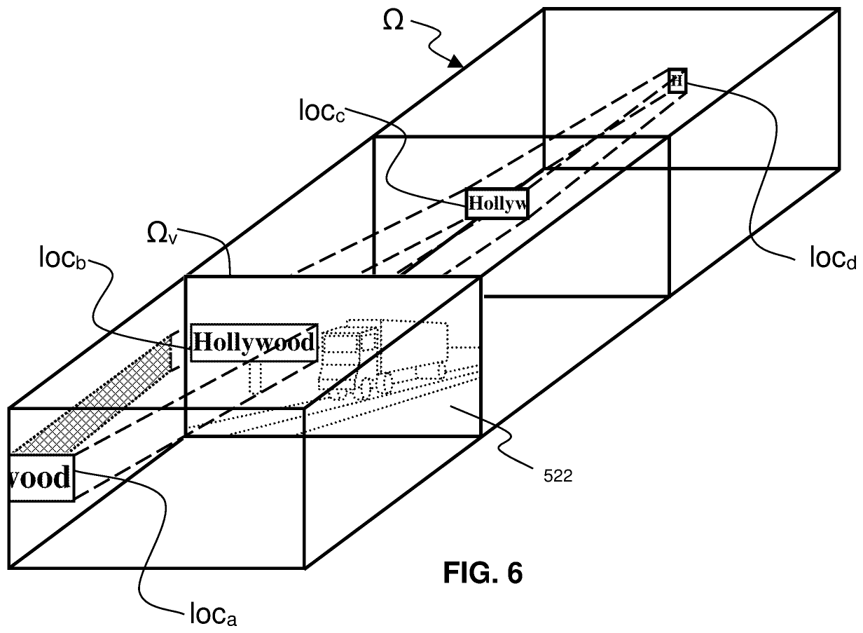

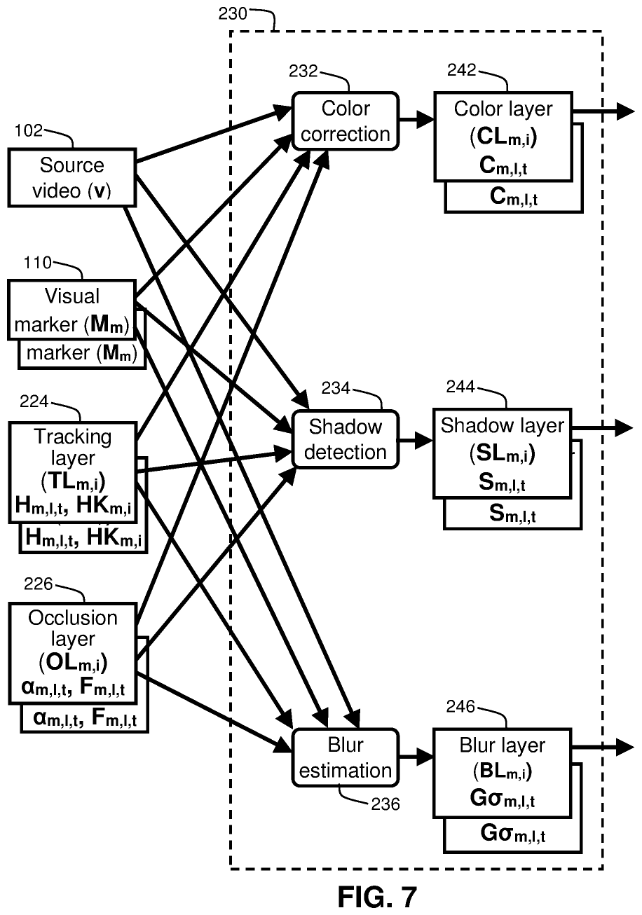

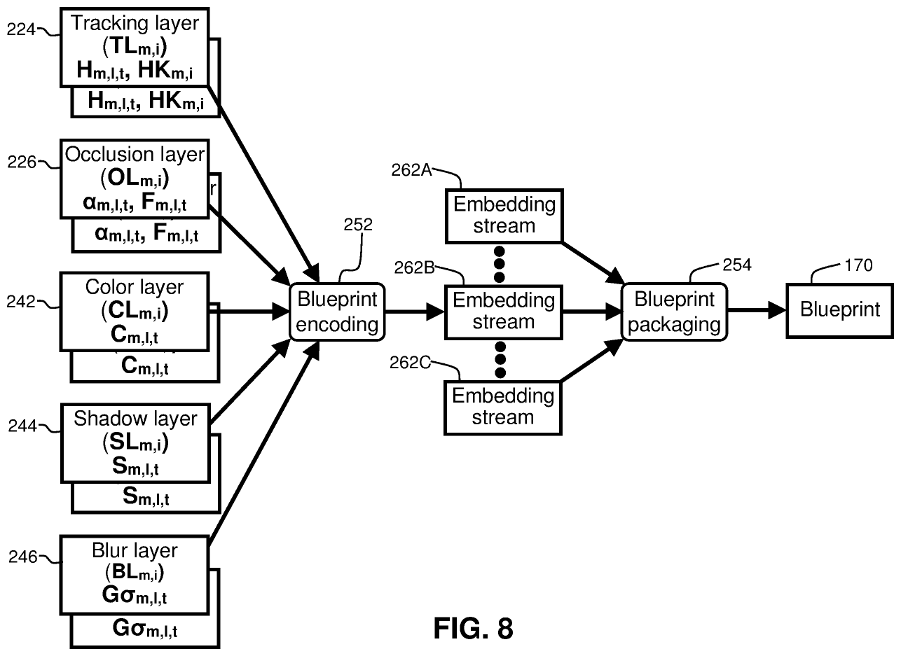

FIG. 3 elaborates the video analysis process shown at 200 in FIG. 1 and FIG. 2. The video analysis process 200 can be divided into three groups of steps or modules:
(a) A visual marker analysis group, shown at 210, that comprises marker detection 212, marker tracking 212, and occlusion processing 214 to create marker tracking information and occlusion layer information from the source video (102 in FIG. 1 and FIG. 2) and the visual marker information (110 in FIG. 1 and FIG. 2). The processing in the visual marker analysis group 210 will be further described with reference to FIG. 4, FIG. 5, and FIG. 6.
(b) A video information extraction group, shown at 230, that comprises color correction 232, shadow detection 234, and blur estimation 236 steps, which can be performed in parallel. The video information extraction group 230 can be used to extract secondary information that can contribute to the visual quality of the output video (190 in FIG. 1). The video extraction group 230 will be further described with reference to FIG. 7.
(c) A blueprint preparation group 250 that comprises a blueprint encoding step 252 and a blueprint packaging step 254. These steps, 252 and 254, facilitate the generation of self-contained artifacts of the analysis called “blueprints” (170 in FIG. 1). The blueprint preparation group 250 will be further described with reference to FIG. 8.

Referring to the video analysis process 200, the notation used to describe the programmatic processing of the source video 102 is follows:
(a) v=R³→R³ means that the source video (v) 102, can be defined as a 3-dimensional domain (x-coordinate, y-coordinate, and frame number or time) that is mapped (as denoted by the right arrow) to a domain of color values (in this case, also a 3-dimensional domain). Thus the source video can also be denoted as v(x,y,t), which defines a specific pixel of a specific frame of the source video. The most common color value domain for videos is a 3-dimensional RGB (red, green, blue) color space, but other tuples of numbers such as the quadruples used for CMYK (cyan, magenta, yellow, and key/black), doubles in RG (red/green used in early Technicolor films), HSL (hue, saturation, and luminance), and YUV, YCbCr, and YPbPr that use one luminance value and two chrominance values could also be used by embodiments of the invention.
(b) Ωᵥ is defined as the spatial domain of the source video (v) 102. Thus, Ωᵥ is a two-dimensional domain of x-coordinates and y-coordinates.
(c) v(t) is defined as a specific frame at time t in the source video (v) 102.
(d) v(t)=Ωᵥ∈R²→R³ is a symbolic representation of the properties of v(t). The 2 dimensions (x-coordinate, y coordinate) of the specific frame t are mapped to a domain of color values, which in this example is a 3-dimensional color space. Each frame is typically a 2-dimensional image file.

The visual marker 110, (or “input marker”, “marker image file”, or more simply “marker”) can be a 2-dimensional (still) image of an object that appears, at least partially, in at least one of the frames in the source video (v) 102. The visual marker 110 could be a specified by a set of corner points or boundaries identified in one frame of the source video, thereby defining a region of the 2-dimensional frame to be used as the 2-dimensional (still) image of the object to be analyzed in conjunction with the source video 102. FIG. 24 illustrates one method for defining a visual marker in this way. In this document and the appended claims:
(a) A marker is denoted by M.
(b) Ω_{M} is the domain of M, which is a mapping of a color-space (typically 3-dimensional RGB) onto the 2-dimensional image: M=Ω_{M}∈R²→R³
(c) Since there can be multiple markers, we use Mₘ to represent a specific marker.

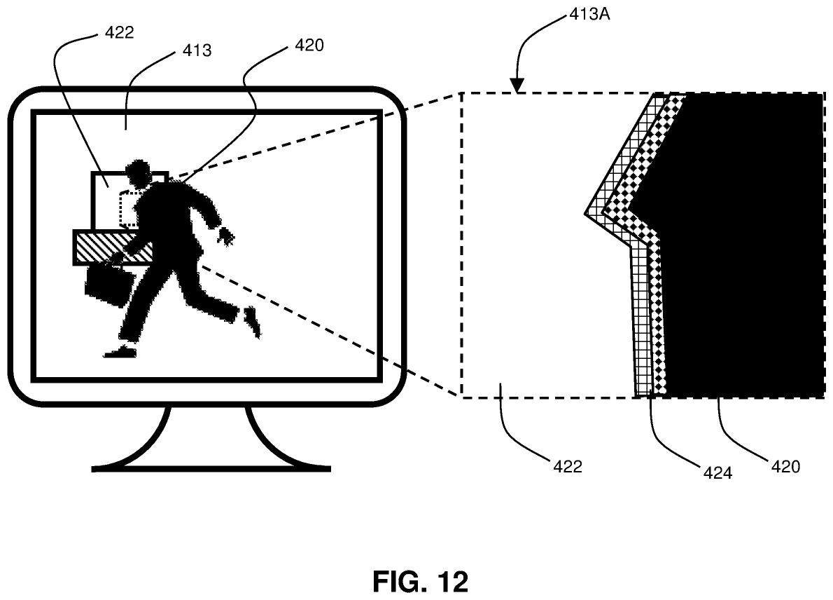

The modules in the visual marker analysis group, shown at 210 in FIG. 3 and FIG. 4, can be used analyze the original source video frame sequence v (102 in FIG. 1 and FIG. 2), to determine the relationship between the video frame sequence v and the visual marker M, (or markers Mₘ) shown at 110 in FIG. 1 and FIG. 2. The following processing is repeated independently for every visual marker Mₘ:
a. First, in the marker detection module 212, frames of the source video (v) 102 are analyzed and a set of detected location data (Lₘ) 222, is produced for each visual marker (Mₘ) 110, as will be discussed in greater detail with reference to FIG. 5A and FIG. 5B. The detected location data Lₘ comprises a frame identifier, a transformation matrix, and a reliability score for each detected location of a visual marker Mₘ in a frame of the source video (v). The reliability scores for each detected location in Lₘ are based on the degree to which there is a matching between the visual marker Mₘ and the region the frame of the source video (v) that was detected as being similar.
b. Then, in the marker tracking module 214, the detected location data (Lₘ) 222 is analyzed starting with the detected location having the highest reliability score. Detected location data is grouped into one or more tracking layers TL_{m,i} (224). The tracking layer data TL_{m,i} comprises grouped sets of frame identifiers and transformation matrices for sequential series of frames in the frame sequence. Detected locations are eliminated from Lₘ as they are grouped and moved to the tracking layer, as will be discussed in greater detail with reference to FIG. 6. The process continues by using the detected location in remaining detected location data Lₘ that has the highest reliability score until all locations in Lₘ have been eliminated.
c. Finally, every Tracking Layer TL_{m,i} 222, together with its corresponding visual marker Mₘ information 110 and the source video (v) 102, are fed to the occlusion processing module 216, which produces a consecutive occlusion layer OL_{m,i} shown at 226 for every tracking layer. FIG. 12 through FIG. 29 provide detail of systems and methods that can be used by the occlusion processing module 216 to optimize the quality of the occlusion layer data.
d. Note that the visual marker analysis group of video processing steps 210 shown in FIG. 4 can produce multiple pairs of tracking layers 222 and occlusion layers 226 for every input visual marker 110. One tracking layer 222 always corresponds to one occlusion layer 226.

Referring to FIG. 5A, which illustrates key steps of the marker detection process 212 in FIG. 3 and FIG. 4, visual markers 110 can have arbitrary sizes and are typically defined by four corner points that can be stretched and warped to fit the rectangular region of a full image frame (the domain Ωᵥ). In many cases a transformation is useful for generalizing computations and ignoring possible differences in sizes of visual markers. Therefore, we will start by normalizing the marker Mₘ by defining and applying a 3 by 3 projective transformation matrix Tₘ that maps the domain Ω_{Mm} to the domain Ωᵥ. The result, shown at 112 is a “normalized visual marker” that is the product of the Tₘ transformation matrix as applied to the original visual marker image Mₘ.

The next step in the marker detection process shown in FIG. 5A is to automatically, systematically, and algorithmically detect the presence, location, size, and shape of normalized markers 112 in frames of the source video (102 in FIG. 1, FIG. 2, and FIG. 4). This detection of parts of an image that look similar to a reference image (or markers) is commonly referred to as image matching. An example of this image matching is shown in the third box of FIG. 5A. The third box of FIG. 5A shows the second frame of the source video (102B in FIG. 2) in dotted lines at 102B overlaid with the normalized visual marker that has been further transformed by a normalized-marker-to-frame transformation matrix H_{m,i} (shown at 114) so that the transformed marker M′_{m,i} 116 most closely matches a section of the second frame of the source video 102B.

There are many known image matching methods that can be used for doing the comparison shown in the third box of FIG. 5A that will generate projective transformation matrixes of the type shown at 114. The SIFT (scale invariant feature transform) algorithm described in U.S. Pat. No. 6,711,293 is one such image matching method. Other methods based on neural networks, machine learning, and other artificial intelligence (AI) techniques can also be used. These methods can provide location data (i.e H_{m,i} matrices), as well as a reliability scores (also called confidence scores) for detected locations markers Mₘ in images, as will be needed for marker tracking (step 214 in FIG. and FIG. 4).

Referring to the third and fourth boxes in FIG. 5A, each detected location (detected_loc, i.e. element of Lₘ, shown at 222 in FIG. 4) can be represented by a 3 by 3 projective transformation matrix H_{m,i} shown at 114, that maps the domain Ωᵥ to the detected location of the marker as shown in the third box of FIG. 5. The projective transformation matrix 114 can also be called a homography map and will be discussed throughout this document. By using the projective transformation matrix H_{m,i} 114, the location of the marker is defined as a quadrilateral within the frame plane. The marker Mₘ can be transformed to fit within the detected location using the following transformation:

M′_{m,i}=H_{m,i}TₘMₘ

where:
Mₘ is the image file of the visual marker, which can be any arbitrary (typically rectangular) size, shown at 110 in FIG. 1, FIG. 2, FIG. 4, and FIG. 5A;
Tₘ is a 3 by 3 projective transformation matrix that maps the domain Ω_{Mm} to the domain Ωᵥ, which can also be described as stretching (and warping if not rectangular) Mₘ to fit the dimensions of a standard frame;
H_{m,i} is the 3 by 3 projective transformation matrix to map the detected location of the marker to detected location i in a frame, shown at 114 in FIG. 5A and FIG. 5B; and
M′_{m,i} shown at 116 in FIG. 5A and FIG. 5B is an image file of the visual marker in location i in the frame and transformed in size and shape to match the feature in the frame that was identified in the marker detection module as shown with an example in the third box of FIG. 5A.

Note that:
(a) Not all frames of the original video must be analyzed in the marker detection step 212, and therefore, the resulting detected marker locations Lₘ can be sparse in time.
(b) Every frame analyzed by the marker detection module 212 may contain zero, one or multiple instances of the Mₘ marker, shown at 110. Every detected instance of the marker in a frame produces a separate candidate location, stored in Lₘ, shown at 222.
(c) In the example illustrated in FIG. 5A, all of the transformations worked with and produced rectangular-shapes. This is not a requirement. Any of these transformations could work with any quadrilateral shape. For example, transformation shown in the fourth box of FIG. 5A that best matches a region of a frame in the third box of FIG. 5A could also have a warped shape such as the transformation shown in FIG. 5B.

Referring to the marker detection process shown in FIG. 5A in another way, the set of detected location data (Lₘ) 222 in FIG. 4, is produced for each visual marker (Mₘ) 110, based on the following relationship:

Lₘ={detected_loc|detected_loc˜Mₘ}

In words, this relationship and process can be described as: Lₘ is defined as a set (“{ . . . }”) of detected locations, such that (“|”) each detected location corresponds (“˜”) to the marker Mₘ. Basically, the market detection module 212 looks for a marker Mₘ in a frame using an image matching algorithm. When this algorithm finds a probable location for Mₘ in a frame, that location goes into the set Lₘ.

A detected location (detected_loc) returned by the marker detection module 212 and placed in Lₘ can be accompanied by a confidence score. The confidence score encodes the “reliability” of a particular detected location for the further tracking. If the pixel pattern found at detected location A more closely matches the transformed marker TₘMₘ (112 in FIG. 5A) than the pixel pattern found at detected location B, then the confidence score for location A would be greater than confidence score for location B. Also, confidence score A is greater than confidence B if the pixel pattern found at location A is closer to a fronto-parallel orientation of the transformed marker TₘMₘ than the pixel pattern found at location B, or if the matching pixel pattern at location A is larger than the matching pixel pattern at location B. The RANSAC algorithm, written by Martin Fischler and Robert Boles, published in 1980, and cited as one of the prior art references, is one example of method for generating and using confidence scores.

Once marker detection 212 has been completed and the set of detected locations and confidence scores for each location have been stored in Lₘ, the detected locations 222 can be organized into a tracking layer TL_{m,I} 224, using the marker tracking process, 214 in FIG. 3 and FIG. 4. The marker tracking process 214 comprises the following actions:
(a) Sorting. Lₘ, which contains all detected locations of marker Mₘ, is sorted in the descending order of the confidence scores.
(b) Keyframe identification. The frame containing the candidate location with the highest confidence score is identified as the keyframe. FIG. 6 shows a keyframe at 522. In the example shown in FIG. 6, the keyframe 522 is the second frame 102B, of the frame sequence 102A, 102B, 102C, and 102D of FIG. 2.
(c) Propagation. Starting with the keyframe 522, the tracking module then analyses every frame forward and backward in time to produce a sequence of locations locₜ which trace the location (picked_loc) within the R³ volume of the original video (102 in FIG. 1 and FIG. 2).
(d) Elimination. Once the marker tracking process is finished for the most “reliable” location (i.e. the one with the highest confidence score), all locations that are already included in the tracking layer data TL_{m,i} are eliminated from the set Lₘ:

L^{k+1}ₘ={detected_loc|detected_loc∈L^{k}ₘ AND detected_loc∉TL_{m,i}}

In words, this means on the next step (“k+1”) set Lₘ is re-defined as a set of detected locations, such that each location is currently in the set Lₘ AND each location is not covered by the tracking layer TL_{m,i}. This process is an update that says: “throw away all detected locations that have already been covered by the tracking layer”.
(e) Find next keyframe. Next, the most “reliable” location remaining in Lₘ is selected, and the process is repeated until every detected location that was in Lₘ 222 has been eliminated and the set of detected locations Lₘ is empty.

FIG. 6 provides a pictorial example of the keyframe identification and propagation actions performed in the tracking process. The domain of the input video v is represented by the rectangular volume shown at Ω and the spatial domain of one frame of the input video v(t) is one time slice of this rectangular volume, as shown at Ωᵥ. The keyframe 522 in this example is the same as frame 102B that was shown in FIG. 2. Referring to FIG. 6 in conjunction with FIG. 2 and FIG. 5A, frame 102B was chosen as the keyframe 522 from the frame sequence 102 in FIG. 2 because the sign that says “Hollywood” in frame 102B most closely matched the normalized visual marker 112 in FIG. 5A. The locations of the normalized marker in the four frames shown in FIG. 6 are given as locₐ, loc_{b}, loc_{c}, and loc_{d}.

Referring to FIG. 5A, FIG. 5B, and FIG. 6, if the frame shown at 102B is the keyframe, then the transformation from the marker to the keyframe is given by M′_{m,i}=H_{m,i} Tₘ Mₘ. To minimize confusion with other transformations that we will be doing, we will substitute HK_{m,i} for H_{m,i} to represent the transformation from the normalized marker (TₘMₘ shown at 112 in FIG. 5A) to the marker in the keyframe (522 in FIG. 6). Thus: M′_{m,i}=HK_{m,i} Tₘ Mₘ at the keyframe for this tracking layer. We will also define the domain transformation ω=HK_{m,i} Tₘ so that the marker at the keyframe for this tracking layer can be expressed as: M′_{m,i}=ω Mₘ

Having defined the transformation from the original visual marker Mₘ (110 in FIG. 1) to a marker location in the keyframe of a tracking layer (TL_{m,i}), we can now define a 3 by 3 projective transformation matrix H_{m,i,t} which maps the marker location at the keyframe M′_{m,i} to the locations of this marker in every other frame of this tracking layer (locₜ). It should be noted that H_{m,i,t} at the keyframe is the identity matrix. The tracking process stops when the marker Mₘ cannot be tracked further, which can occur when (a) the scene changes, (b) the marker becomes fully occluded by some other object in the scene, and/or (c) when the beginning or end of the frame sequence is reached.

Thus, in one embodiment of the invention, the tracking layer TL_{m,i} comprises:
(a) a keyframe designator that identifies which frame in a sequence is the keyframe;
(b) transformation matrix (or matrices) used for converting a marker image to a marker location in the keyframe (MK_{m,i}, HK_{m,i} Tₘ, or ω, depending upon whether the image has previously been normalized);
(c) information that identifies the current frame (t); and
(d) a set of projective transformation matrices H_{m,i,t}. These projective transformation matrices H_{m,i,t} can be used to convert the normalized marker image at the keyframe M′_{m,i}=HK_{m,i} Tₘ Mₘ into a marker location for every frame of the video frame sequence that contains the marker Mₘ.

Note that, although the location data in Lₘ (shown at 222 in FIG. 4) might have been sparse, the tracking layer (shown at 224 in FIG. 4) is not sparse. It contains every frame of a sequence from the first frame in which a marker at a tracked location was detected to the last frame in which this marker was detected.

Although the visual marker (110 in FIG. 1 and FIG. 2) is most likely to be fully visible at the keyframe (522 in FIG. 6), it might well be partially occluded in other frames within the track layer. The occlusion processing module 216 in FIG. 4 takes the original source video (102 in FIG. 1 and FIG. 2) the tracking layer TL_{m,i} (224 in FIG. 4), and the location of the visual marker relative to its location in the keyframe (H_{m,i,t}) to produce a sequence of masks, and more specifically alpha masks α_{m,i,t} that separate visible parts of the marker from occluded parts at every frame within the track layer. For every tracking layer TL_{m,i} 224 the occlusion processing module 216 produces one occlusion layer OL_{m,i} 226. Every occlusion layer contain a consecutive sequence of alpha masks α_{m,i,t} and typically also contains a sequence of foreground images F_{m,I,t}.

Alpha masks can be used to decompose an original image I into foreground Fg and background Bg using the following:

$$I = ( 1 - α ) Bg + ( α ) Fg$$

$$Where : 0 \leq α \leq 1 .$$

This decomposition allows the replacement of the background with the new visual content. For better quality of the result, the foreground should be estimated together with the alpha mask. In this case, a new image is computed as:

$$I\_new = ( 1 - α ) Bg\_new + ( α ) F g$$

If the occlusion processing method of choice does not provide foreground estimations, an approximate new image can be computed as:

$$I\_new = ( 1 - α ) Bg\_new + ( α ) I$$

FIG. 12 to FIG. 29 and the associated descriptions provide a more detailed description of methods and systems that can be used to perform the occlusion processing shown at 216 in FIG. 4 to produce alpha masks α_{m,i,t} and foreground images F_{m,i,t} that are stored in the occlusion layer 226 in FIG. 4.

The functionality shown at 230 in FIG. 7 is used to perform a supplementary analysis of the original video. This supplementary analysis is not strictly required, but nevertheless contributes substantially to the visual quality of the final result. All modules in the second group are independent from one another and thus can work in parallel.

Referring to the color correction module 232 in FIG. 7, due to changes in illumination conditions, the appearance of a given visual marker in terms of its colors and contrast might change over time. However, the location of the visual marker still should be detected and tracked correctly. Illumination conditions might change, for instance, due to a change in lightning of the scene or a change in camera orientation and settings. It is expected that both the visual marker detection and the tracking modules are to some extent invariant to such changes in illumination. On the other hand, the invariance of the prior modules (marker detection, marker tracking, and occlusion processing) to the changes in colors and contrast means that the information about those changes is deliberately discarded and should be recovered at later stages. The color correction module takes the corresponding Track Layer TL_{m,i} 224 and Occlusion Layer OL_{m,i} 226 as well as the source video 102 and the visual marker Mₘ 110 as its inputs. Recall that v (t) denotes a frame of the source video v at the time t.
Let v(locₜ)=v(t, locₜ) denote a portion of that frame, specified by the location locₜ.
The transformation that maps marker Mₘ to location locₜ is given by:

T=H_{m,i,t}HK_{m,i}Tₘ

Based on the preceding, marker Mₘ can be transformed to fit within the location locₜ as: M′=TₘMₘ. The transformed version M′ can then be compared with v(locₜ) in terms of colors features. In this comparison the marker is considered as a reference containing true colors of the corresponding visual element. A color transformation C_{m,i,t} can be estimated by the color correction module, within the domain of locₜ such that:

v(locₜ)≈(H_{m,i,t}HK_{m,i})C_{m,i,t}(TₘMₘ)

### Where:

v(locₜ) is a portion of the frame, specified by the location locₜ
Tₘ is the stretching of marker to a rectangular image (normalization)
TₘMₘ is the marker image stretched to fit an entire frame (normalized)
C_{m,i,t} is the color transformation for a specific frame
HK_{m,i} is the transformation at the keyframe
H_{m,i,t} is transformation from the keyframe to a specific frame

For every tracking layer TLₘᵢ and occlusion layer OL_{m,i} pair, the color correction module produces one color layer CL_{m,i}. Every color layer contains a consecutive sequence of parameters that can be used to apply color correction C_{m,i,t} to the visual content during the rendering process.

The occlusion processing module 216 discussed with reference to FIG. 4 should distinguish between mild shadows, casted over a marker, and occlusions. To distinguish these, shadows are extracted by the shadow detection module, shown at 234 in FIG. 7 and this information can later be reintegrated over new visual content. The detection of shadows is more reliable when the frame, which contains shadows, can be compared with an estimation of the background, which has no objects or moving cast shadows. In the current context it can be assumed that v(loc_{key}) at the keyframe contains no shadows. Alternatively, the marker Mₘ 110 can be transformed using M′ₘ=HK_{m,i} Tₘ Mₘ and overlaid over the keyframe to create the desired clean background.

It is possible to use the assumption that regions under shadow become darker but retain their chromaticity, which is a component of a color that is independent from intensity. This assumption simplifies the process and is computationally inexpensive. Although they are sensitive to strong illumination changes and thus fail in the presence of strong shadows, such methods still can be applied in the shadow detection module, 234 of FIG. 7, to handle mild shadows, if the selected occlusion processing method takes strong shadows for semi-transparent occlusions. The proposed workflow allows occlusion and shadow detection methods to complement each other. Such simple shadow detectors can be enhanced by taking texture information into account. Initial shadow candidates can be classified as shadow or non-shadow by correlating the texture in the frame with the texture in the background reference. Different correlation methods can be used, for instance, normalized cross-correlation, gradient or edge correlation, orthogonal transforms, Markov or conditional random fields, and/or Gabor filtering.

In one embodiment, for every tracking layer (TL_{m,i}) 224 and occlusion layer (OL_{m,i}) 226 pair, the shadow detection module 234 can produce one shadow layer (SL_{m,i}) 244. Every shadow layer can comprise a consecutive sequence of shadow masks (S_{m,i,t}) that can be overlaid over a new visual content while rendering. Usually shadows can fully be represented by relatively low frequencies. Therefore, shadow masks can be scaled down to reduce the size. Later at the rendering time, shadow masks can be scaled back up to the original resolution either using bi-linear interpolation, or faster nearest neighbor interpolation followed by blurring.

Natural images and videos often contain some blurred areas. Sometimes blur can appear as a result of wrong camera settings, but it is also frequently used as an artistic tool. Often the background of a scene is deliberately blurred to bring more attention to the foreground. For that reason, it is essential to handle blur properly when markers are placed in the background. The purpose of the blur estimation module shown at 236 in FIG. 7 is to predict the amount of blur within the v(locₜ) portion of a video. The predicted blur value can be used to later apply the proportional amount of blurring to a new graphics substituted over the marker. Blur estimation can be done using a “no-reference” or a “full-reference” method. No-reference methods rely on such features as gradients and frequencies to estimate blur level from a single blurry image itself. Full-reference methods estimate blur level by comparing a blurry image with a corresponding clean reference image. The closer the reference image matches the blurry image, the better the estimation. A full-reference method fits well in the current context, because the transformed marker M′=H_{m,i,t} HK_{m,i} Tₘ Mₘ can be used as a reference. For every tracking layer TL_{m,i} 224 and occlusion layer OL_{m,i} 226 pair, the blur estimation module can produce one blur layer BL_{m,i} 246. Every blur layer 246 contains a consecutive sequence of parameters σ_{m,i,t} that can be used to apply blurring Gσ_{m,i,t} to visual content during the rendering process.

The information extracted by the tracking, occlusion processing, color correction, shadow detection, and blur estimation modules described herein can be used to embed new visual content (still images, videos or animations) over a marker. The complete embedding process can be represented by a chain of transformations:
Let I=Ω_{I}∈R²→R³ be new visual content to be substituted over marker Mₘ.
Let T_{I} be a 3 by 3 projective transformation matrix that maps the domain Ω_{I} to the domain Ωᵥ.
Then the full chain of operations that produces a new frame is:

$${v}^{′} ( t ) = {α}_{m , i , t} ( ( {H}_{m , i , t} {HK}_{m , i} ) G {σ}_{m , i , t} {C}_{m , i , t} ( {T}_{m , I} {I}_{m} ) + {S}_{m , i , t} ) + ( 1 - {α}_{m , i , t} {F}_{m , i , t} )$$

where:
v′(t) is the modified frame of the source video at time t
α_{m,i,t} is the alpha channel from occlusion processing
H_{m,i,t} is transformation from the keyframe to a specific frame
HK_{m,i} is the transformation at the keyframe
Gσ_{m,i,t} is the blur transformation
C_{m,i,t} is the color transformation
T_{m,I} is the transformation of Iₘ, which is the new image to replace marker m
S_{m,i,t} is the shadow mask
α_{m,i,t} is the alpha mask, created by the occlusion process; and
F_{m,i,t} is the image foreground, created by the occlusion process.

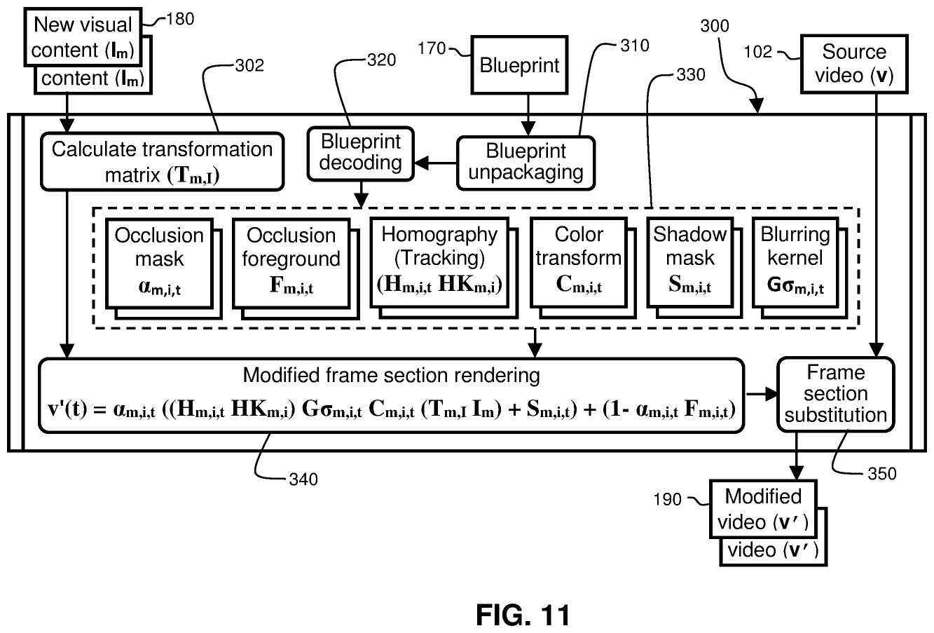

FIG. 8 illustrates the processing modules for implementing blueprint encoding 252 and blueprint packaging 254, which are the third portion (blueprint preparation 250) of the analysis process 200 shown in FIG. 3. The modules 252 and 254 shown in FIG. 8 are responsible for wrapping the results of all of the prior steps into a single file called a “blueprint” 170. A blueprint file can easily be distributed together with its corresponding original video file (or files) (102 in FIG. 1) and used in generation phase that was shown at 300 in FIG. 1, and will be further described with reference to FIG. 11.

Further referring to FIG. 8 the data that is encoded 252 and packaged 254 can comprise the tracking layer 224, the occlusion layer 226, the color layer 242, the shadow layer 244, and the blur layer 246. The visual marker (Mₘ) shown at 110 in FIG. 1 is no longer needed for the blueprint 170 because all of the information from the visual marker has now been incorporated in the layer information. In particular, the foreground layer F_{m,i,t} and occlusion mask α_{m,i,t} contain the necessary information for doing an image substitution of the marker. The encoding process creates an embedding stream, shown at 262A, 262B, and 262C. Each embedding stream comprises an encoded set of data associated with a specific marker (m) and tracked location (i).

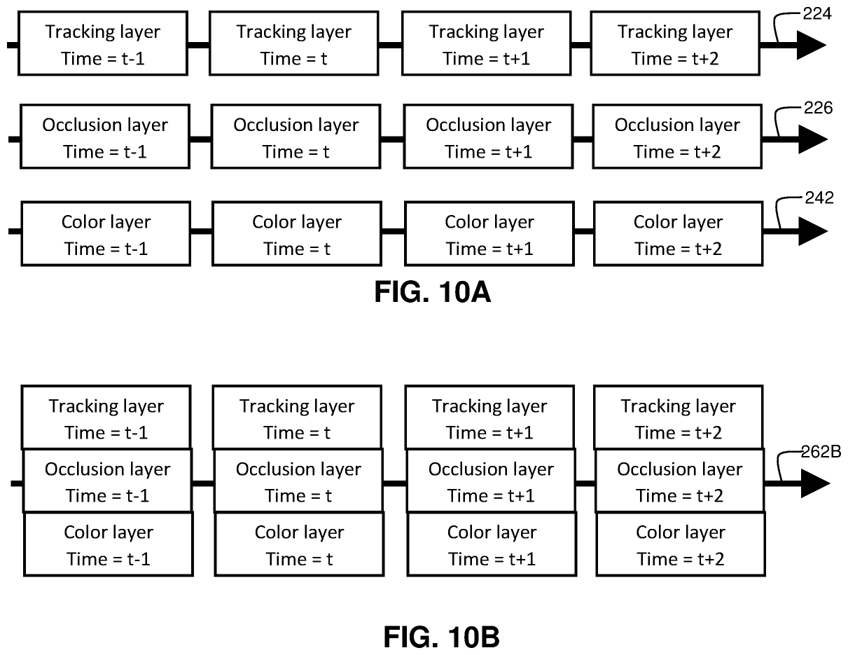

Referring to FIG. 8, FIG. 10A, and FIG. 10B, in blueprint packaging 254, one or more embedding streams (such as 262A, 262B, and 262C) are formatted into a blueprint format 170 that is compatible with an industry standard such as the ISO Base Media File Format (ISO/IEC 14496-12-MPEG-4 Part 12). Such standard formats can define a general structure for time-based multimedia files such as video and audio. ISO Base Media File Format for the blueprint file fits well in the current context because all the information obtained in the video analysis process (200 in FIG. 1 and FIG. 2) is represented by time-based data sequences: track layers, occlusion layers, etc. The ISO Base Media File Format (ISO BMFF) defines a logical structure whereby a movie contains a set of time-parallel tracks. It also defines a time structure whereby tracks contain sequences of samples in time. The sequences can optionally be mapped into the timeline of the overall movie in a non-trivial way. Finally, ISO BMFF file format standard defines a physical structure of boxes (or atoms) with their types, sizes and locations.

The blueprint format 170 extends ISO BMFF by adding a new type of track and a corresponding type of sample entry. A sample entry of this custom type contains embedding data for a single frame. In turn, a custom track contains complete sequences (track layers, occlusion layers, etc.) of for the embedding data. ISO BMFF extension is done by defining a new codec (and sample format) and can be fully backwards compatible. Usage of ISO BMFF enables streaming of the blueprint data to a slightly modified MPEG-DASH-capable video player for direct client-side rendering of videos. Blueprint data can be delivered using a separate manifest file indexing separate set of streams. Alternatively, streams from a blueprint file can be muxed side-by-side with the video and audio streams. In the latter case, a single manifest file indexes the complete “dynamic video”. In both cases a video player can be configured to consume the extra blueprint data to perform embedding. For back compatibility the original video without embedding can be played by any existing video player.

Further referring to FIG. 8, a sequence of sample entries generated by the blueprint encoder 252 is written to an output blueprint file according to the ISO/IEC 14496-12-MPEG-4 Part 12 specification: serialized binary data is indexed by the trak box and is written to the mdat box together with any extra data necessary to initialize the decoder (320 in FIG. 11). A single blueprint file may contain many sequences of sample entries (“tracks” in the ISO BMFF terminology).

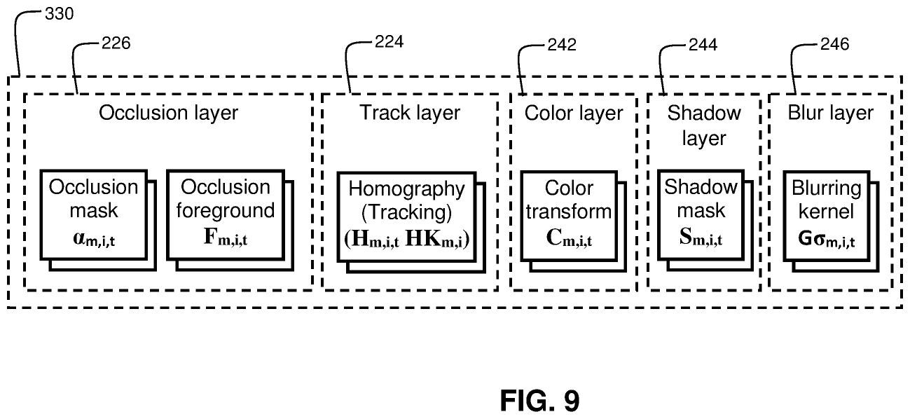

FIG. 9 shows the types of layers produced during the video analysis process (200 in FIG. 1) that are stored as part of the frame modification data 330 in FIG. 9. Each layer is a consecutive sequence of data frames. For instance, for the occlusion Layer one data frame consists of one occlusion mask and one estimated foreground. More specifically, the frame modification data 330 can comprise:
(a) An occlusion layer 226 comprising an occlusion mask 331 that comprises one alpha mask for every frame in the layer as well as occlusion foreground information 332 comprising one image file for every frame in the layer;
(b) A tracking (or track) layer 224 comprising the homography or tracking information that comprises as set of files, one for each frame, that comprise the homographic transformation to the keyframe HK_{m,i} as well as the homography from the keyframe to each frame in the track H_{m,i,t};
(c) A color layer 242 that comprises one (or more) alpha mask(s) for every frame in the layer;
(d) A shadow layer 244 that comprises one alpha mask for every frame in the layer; and
(e) A blur layer 246 that comprises one alpha masks for every frame in the layer.

Referring to FIG. 10A and FIG. 10B, a custom blueprint encoder (252 in FIG. 8) can be used to take all of the layers corresponding to the same keyframe location HK_{m,i}, as shown for a tracking layer 224, occlusion layer 226, and color layer 226 in FIG. 10A and serialize them into a single sequence of sample entries, as shown for the embedding stream 262B in FIG. 10B. Data frames from different layers corresponding to the same timestamp t are serialized into the same sample entry. Note that some data, does not change from frame to frame in a layer (such as the keyframe location HK_{m,i}) can be stored in the metadata for the blueprint file.

FIG. 11 illustrates the main elements of the generation phase, which are blueprint unpackaging 310, blueprint decoding 320, modified frame section rendering 330, and frame section substitution 340. A blueprint file 170 can be parsed (unpackaged, as shown at 310) by any software capable of parsing ISO BMFF files. A set of tracks is extracted from the blueprint file 170. For every track, the decoder 320 is initialized using the initialization data from the mdat box. The blueprint decoder 320 deserializes sample entries back into data frames and thus reproduces the frame modification data 330 comprising:
(a) A tracking layer comprising the homography (H_{m,i,t} and HK_{m,i}) data;
(b) An occlusion layer comprising the occlusion mask and occlusion foreground (α_{m,i,t} and F_{m,i,t}) data;
(c) A color transform layer comprising C_{m,i,t} data;
(d) A shadow mask layer comprising the S_{m,i,t} data; and
(e) A blurring kernel layer comprising the Gσ_{m,i,t} data.

Regarding modified frame section rendering 340, the decoded layers 330 contain all data necessary for substitution of a new visual content for the creation of a new video variant for the sections of the frames where a marker was detected. Given a frame v (t) from the original video, the new visual content I=Ω_{I}∈R²→R³ is copied inside the substitution domain in order to create a new frame v′(t). This frame section substitution 350 uses the results of the modified frame section rendering 340. Values outside of the substitution domain are copied as-is. New values within the substitution domain are computed using the following chain of operations as shown at 340:

$${v}^{′} ( t ) = {α}_{m , i , t} ( ( {H}_{m , i , t} {HK}_{m , i} ) G {σ}_{m , i , t} {C}_{m , i , t} ( {T}_{m , I} {I}_{m} ) + {S}_{m , i , t} ) + ( 1 - {α}_{m , i , t} {F}_{m , i , t} )$$

The chain of rendering operations in the above equation can be described as follows:
(a) First, the new visual content Iₘ is transformed by T_{m,I} to fit to the video frame. Note that the transformation matrix T_{m,I} must be calculated from the new visual content Iₘ 180 by rescaling (and possibly reshaping) the domain of I (Ω_{I}) to the domain of the video (Ωᵥ) so that it has a “standard size”.
(b) Second, the color correction C_{m,i,t} is applied.
(c) Third, smoothing by Gaussian blur Gσ_{m,i,t} is applied.
(d) Then the result is transformed by the tracking information (H_{m,i,t} HK_{m,i}) to fit within the substitution domain.
(e) Shadow mask S_{m,i,t} is applied to finish the transformation.
(f) Finally, alpha mask α_{m,i,t} is used to blend the transformed visual content and the estimated foreground F_{m,i,t}. If the occlusion processing method of choice does not provide foreground estimation, the original frame v(t) can be used instead of F_{m,i,t}.

The above chain of rendering operations is repeated for every marker m, and every appearance of this marker i, and in every frame t where the marker m was detected. In the frame section substitution module 350, the blueprint can be used to modify only the frames of the output video where the marker was found, with all of the rest of the source video being used in its unmodified form.

Note that, if there is no color, shadow, or blur layer, the modified frame rendering equation shown at 340 in FIG. 11 and detailed above, simplifies to the following:

$${v}^{′} ( t ) = {α}_{m , i , t} {H}_{m , i , t} {HK}_{m , i} {T}_{m , I} {I}_{m} + ( 1 - {α}_{m , i , t} {F}_{m , i , t} )$$

### 4. AUTOMATED PARTIAL BACKGROUND REPLACEMENT IN VIDEO FRAME SEQUENCE

FIG. 2 shows an example of a digital video frame sequence in which a part of the background content of the frame sequence (in this case a billboard that said “Hollywood”) has been replaced without changing the active foreground object (in this case, a truck) in the sequence. Performing this this type of video content replacement in a high quality and automated way requires careful management and processing of regions of a video frame where occlusions occur.

FIG. 12 shows a video image 413 and detail 413A of set of the pixels located at the external boundaries of a foreground object in an original unmodified digital video frame, in this case an occluded computer screen in the background 422 behind a man in the foreground 420. Because of the discrete nature of the image acquisition systems (e.g. digital cameras or scanners), information from the foreground occluding object and the background occluded object is mixed at those pixels that are placed between the boundary of the objects 424. This circumstance is presented in nonmodified videos. Thus, compositions created by video editing tasks using only this (occluded/non-occluded) binary (non-overlapped) classification are unrealistic. To overcome this issue, a third class must be added. This new class is the partially-occluded class and it represents the pixels that contain color values from both (occluding/occluded) objects. Furthermore, in order to make realistic video compositions, a new information at pixels belonging to the new class, should be inferred jointly with the classification. This new information is the amount of mixture between occluding/occluded objects and the pure color of the occluding object.

The classification into these three different classes can be done manually by an expert, but the manual classification and foreground color estimation on those areas where the information is mixed is error prone and too much time consuming, i.e. not feasible for long duration videos.

On the other hand, automatic segmentation of pixels into foreground, background or as a combination of both classes can be performed frame by frame by means of solving the α-matting problem as if frames were independent images each other. Solving the α-matting problem is the task of: given an image I(x, y) ((x,y) represents pixel location) and a trimap mask T(x, y) as inputs, produce an α-mask α(x, y) that codes the level of mixture between an arbitrary foreground Fg(x, y) and background Bg(x, y) in such a way that the equation I=(1−α)Bg+α(Fg), where 0≤α≤1, is fulfilled for every pixel (x, y). The trimap mask is an image indicating for each pixel if the corresponding pixel is 100% sure that it is pure foreground, 100% sure that it is pure background or unknown. The α-matting problem is an ill-posed problem because for each pixel, the α-matting equation to solve is undetermined as the values for α, Fg and Bg are unknown. To overcome this drawback, it is usual to use the trimap to make an estimation of the color distribution for the foreground and background objects. Such methods often rely on color extraction and modelling inputs from the trimap (sometimes manually) to get good results, but such methods are not accurate in cases where foreground and background pixels have similar colors or textures.

Deep learning based methods can be classified into two types, 1) those methods that use deep learning techniques to estimate the foreground/background color estimation and 2) those methods that try to learn the underlying structure of the most common foreground objects and do not try to solve the α-matting equation. In particular, the latter methods overcome the drawbacks of color-based methods training a neural network system that is able to learn most common patterns of foreground objects from a dataset composed by images and their corresponding trimaps. The neural network system makes inference from a given image and the corresponding trimap. This inference is based not only in color, but also in structure and texture from the background and foreground information delimited by the trimap. Although the deep learning approach to the α-matting problem is more accurate and (partially) solves the problem of the color-based methods, the drawback is that they still rely on a trimap mask. Moreover, its application to video is not the optima because it does not have into account temporal consistency of the generated mask in a video sequence.

To reasonably describe and illustrate the innovations, embodiments and/or examples found within this disclosure, let's describe the problem in a mathematical terminology.

### Let

v:Ω×[0,τ]→ [symbol] ^{M}

(x,y,t) [symbol] v(x,y,t)

be a function modelling a given grey (M=1) or color (M>1) video, where:
v belongs to L^{∞}(Ω×[0,τ]) space, the space of Lebesgue measurable functions v such that there exists a constant c such that |v(x)|≤c. a.e. x∈Ω×[0,τ]);
Ω×[0,τ] is the (spatio-temporal video) domain;
Ω⊂ [symbol] ² is an open set of [symbol] ² modelling the spatial domain (where the pixels are located);
(x, y)∈Ω is the pixel location within a frame and [0, τ] with τ≥0 denotes frame number within a video, i.e., v(x, y, t) represents the color at pixel location (x, y) in the frame t.

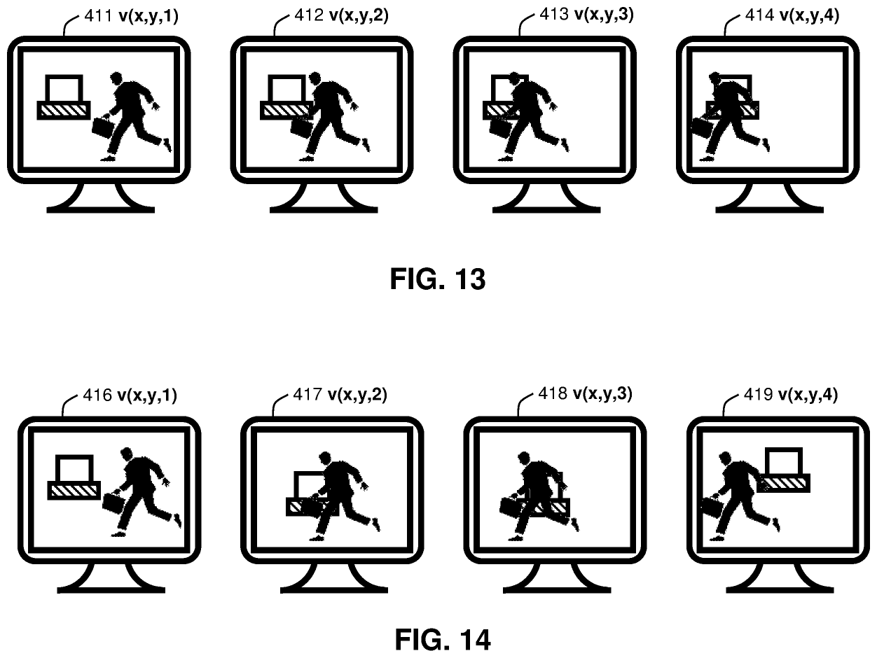

Examples of types of videos, but not restricted to, are shown in FIG. 13 in which the man moves in front of a stationary computer as shown at 411, 412, 413, and 414, and FIG. 14, in which both the computer and the man move from locations in the video frame sequence shown at 416, 417, 418, and 419. Let:
s(x, y) be a reference frame and let

H:Ω×[0,τ]→ [symbol] ²

(x,y,t) [symbol] (h₁(x,y,t),h₂(x,y,t)

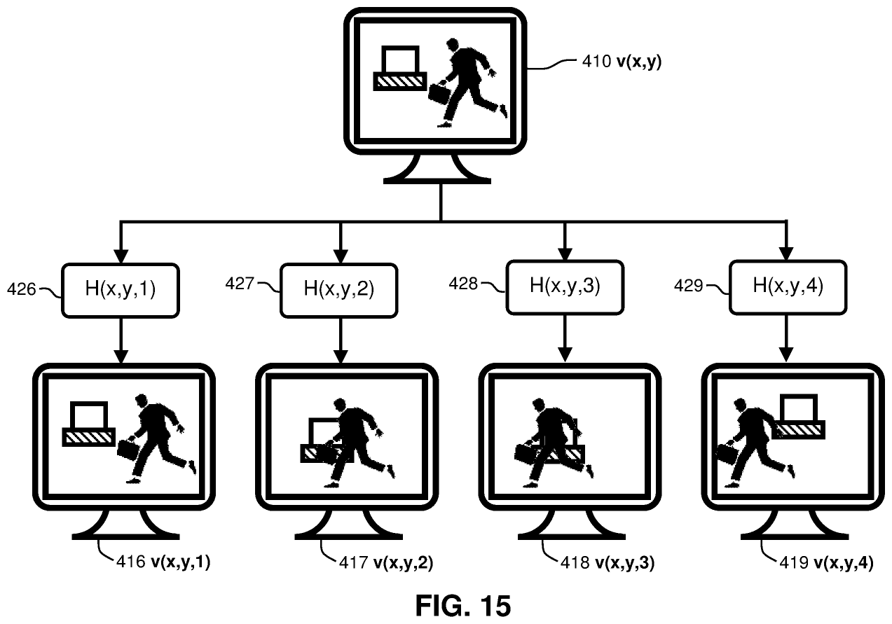

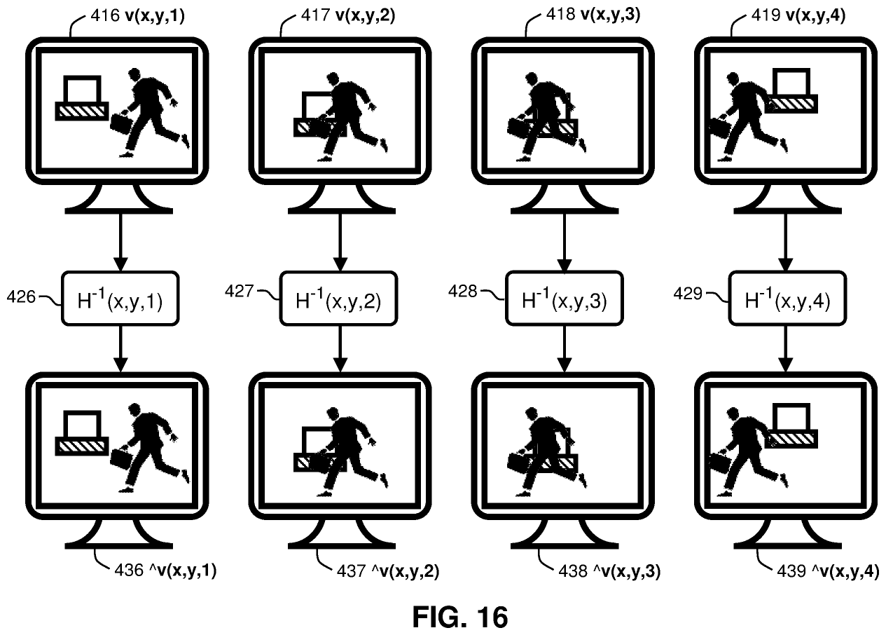

be a map modelling a (rigid or non-rigid) transformation from the reference frame s to each video frame minimizing some given (and known) metric that allows H(x, y, s) to be the identity transform. An example of an effect that can be modeled by H, but not restricted to, is the camera movement of FIG. 14. An example of how a computed H can act over the video from FIG. 14 is shown in FIG. 15 (direct transformation) and FIG. 16 (inverse transformation). In FIGS. 15, 416, 417, 418 and 419 are created from 410 using the transformation H, which comprises 426, 427, 488, and 429. In FIG. 16 an inverse transform (431, 432, 433, and 434) is used to go from the frames shown at 416, 417, 418, and 419 to the frames shown at 436, 437, 438, and 439.

Let ω⊆Ω be a known region of the reference frame s. We can then model the classification function as:

O:ω×[0,τ]→[0,1]

(x,y,t) [symbol] α(x,y,t)

in such a way that:
α(x, y, t)=0 if (H(x, y, t), t) is non-occluded;
α(x, y, t)=1 if (H(x, y, t), t) is occluded; and
α(x, y, t)=c∈(0, 1) if (H(x, y, t), t) is partially-occluded

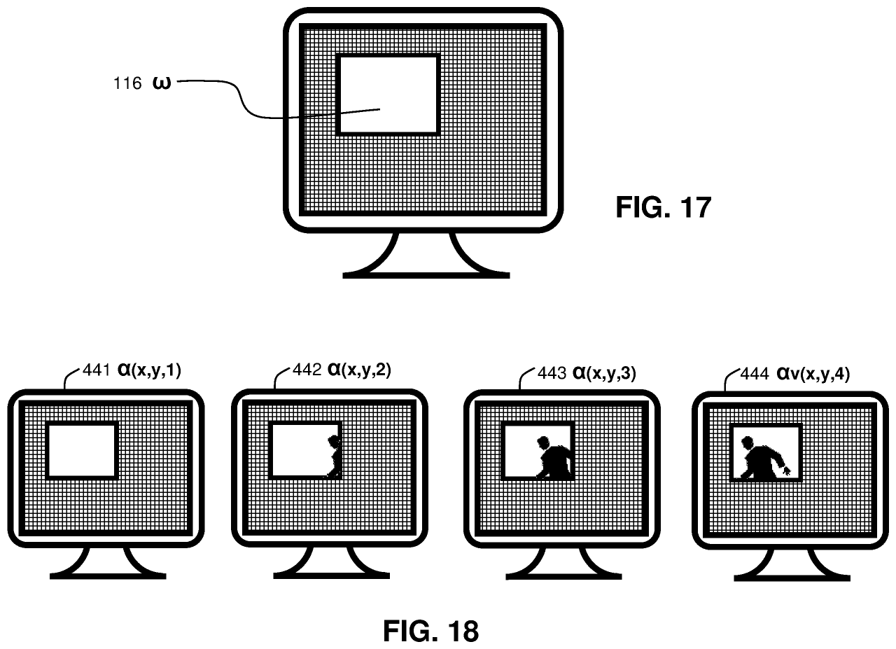

An example of region ω 116 is shown in FIG. 17. An example of a computed occlusions function α is shown at 441, 442, 443, and 444 in FIG. 18.

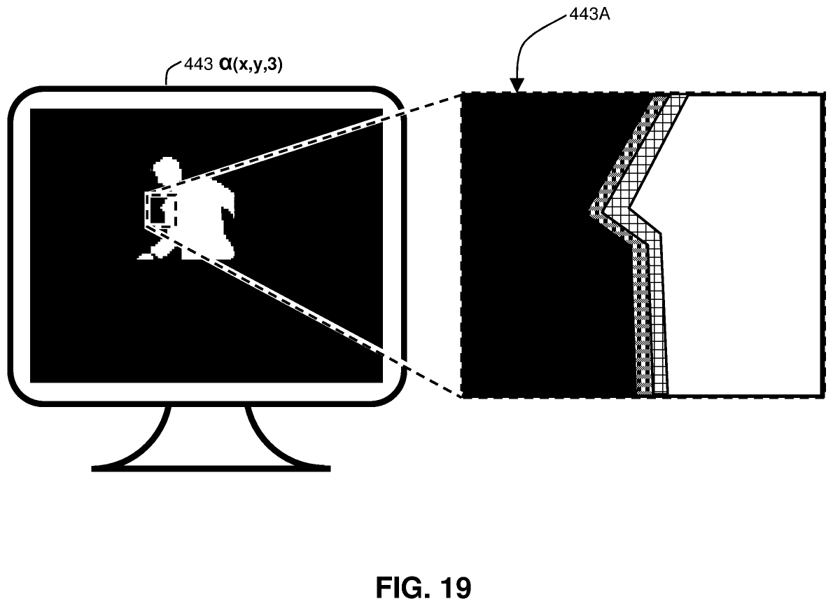

FIG. 19 shows detail of occlusions on 413 of FIG. 12 and FIG. 13, which is also 443 in FIG. 18. White means occluding pixels, black means non-occluding (neither occluded) pixels and the shaded partially black and partially white regions means partially occluded pixels. The amount of occlusion is represented by the amount of white, the whiter the foreground color the greater the occlusion strength.

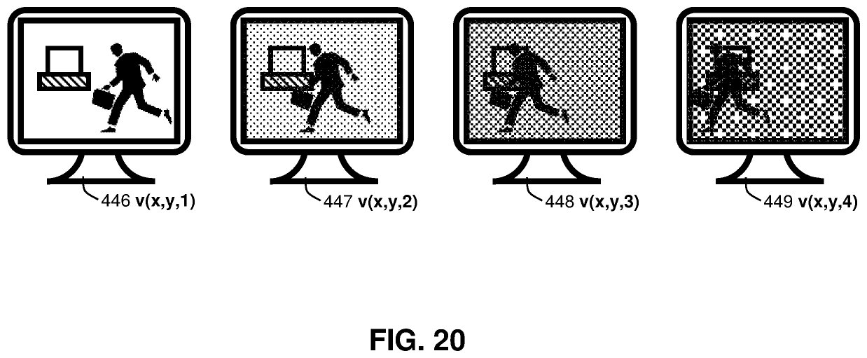

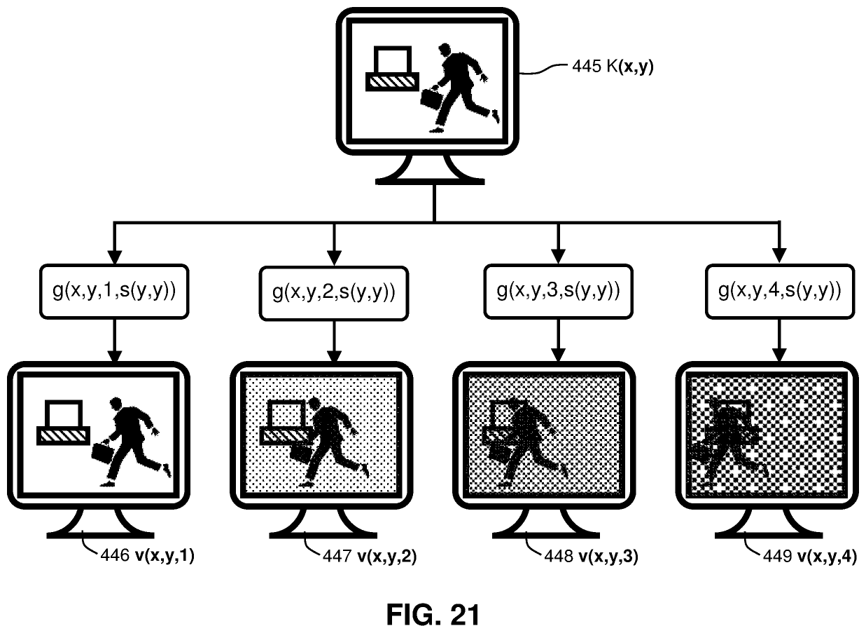

Referring to FIG. 20 and FIG. 21, we can define the color of a pixel in reference frame K with respect to the registered coordinates of a particular frame t as:

color=v(H⁻¹(x,y,t),K)

and let

g:ω×[0,τ]× [symbol] ^{M}→ [symbol] ^{M}

(x,y,t,color) [symbol] v(x,y,t) if α(x,y,t)=0

(x,y,t,color) [symbol] g(x,y,t,color) if α(x,y,t)>0

be a color mapping function that models color change between reference frame s and frame t. Examples of physical aspects of the video that can be modeled by g, but not restricted to, are: global or local illumination, brightness or white balance changes among others. An example of a video with a global illumination changes is shown at 446, 447, 448, and 449 in FIG. 20. An example of how function g modelling the illumination change of video in FIG. 20 affects to the reference frame is shown at 445, 446, 447, 448, and 449 in FIG. 21.

Finally, let:

f:ω×[0,τ]→ [symbol] ^{M}

(x,y,t) [symbol] v(x,y,t) if α(x,y,t)∈{0,1}

(x,y,t) [symbol] if(x,y,t) if 0<α(x,y,t)<1

be a function, representing foreground colors, such that:

∇(x,y)∈H(ω,t);

$$∃ ϵ ∈ ℝ : \vert v ( x , y , t ) - ( 1 - α ( x , y , t ) ) g ( \hat{x} , \hat{y} , t , v ( \hat{x} , \hat{y} , K ) ) + α ( x , y , t ) f ( x , y , t ) \vert \leq ϵ$$

where:
(\hat{x},ŷ)=H⁻¹ (x, y, t) is the corresponding transformed coordinate; and
   |·| is a suitable norm defined over [symbol] ^{M}.

An example of norm, but not restricted to, is the Euclidean norm defined by:

$$\vert ( {w}_{1} , … , {w}_{M} ) \vert = {( {\sum }_{i = 1}^{M} {( {w}_{i} )}^{2} )}^{0.5}$$

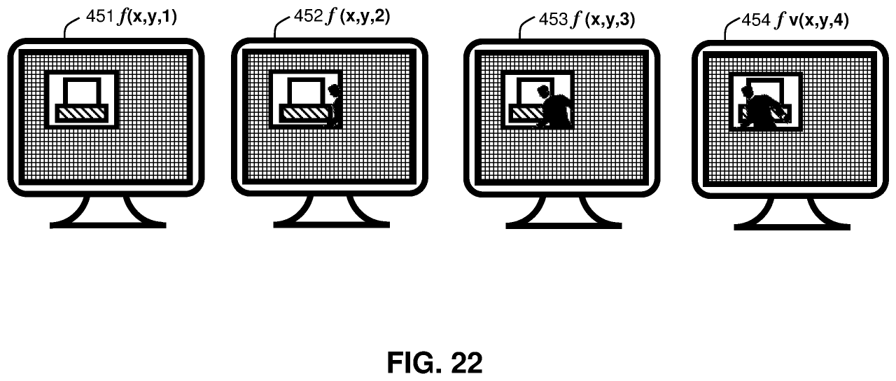

The digital video frame sequence shown at 451, 452, 453, and 454 in FIG. 22 is an example of this function.

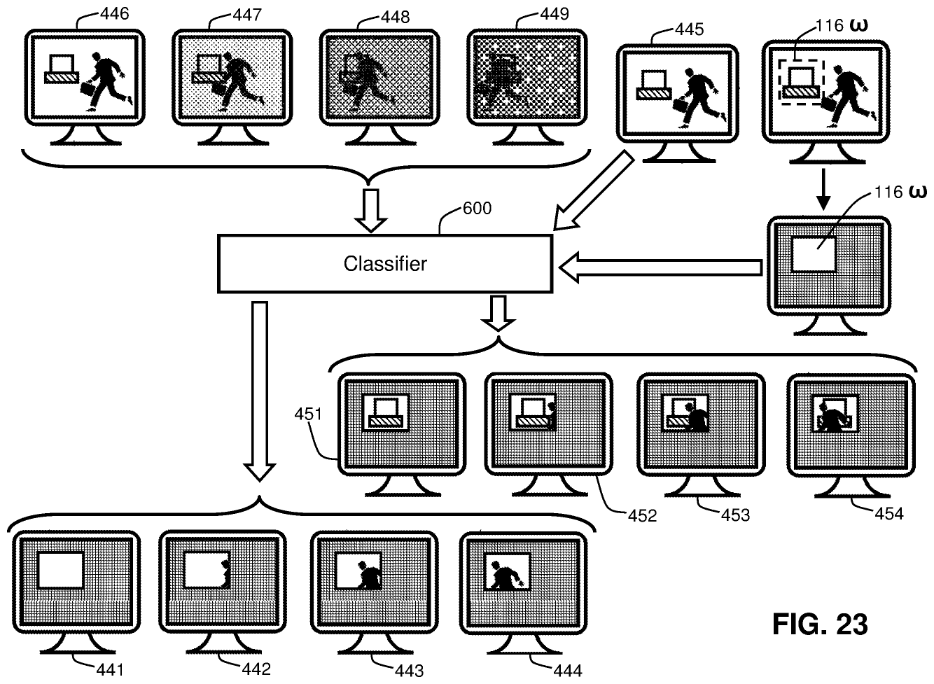

FIG. 23 combines the information presented with FIG. 12 to FIG. 22 and shows the classifier that will be explained with reference to FIG. 24 to FIG. 29. As shown in FIG. 23, in one embodiment, the present invention comprises a method and/or computer implemented system for the efficient estimation of the classifying function α(x, y, t) and foreground color function f(x, y, t) given:
A gray or color video v(x, y, t)
A reference frame K(x, y)
A region ω⊂Ω of pixels to classify.
The transformation H(x, y, t) that maps coordinates from reference frame s to any frame t.
The color change function g(x, y, t, color) mapping colors from reference frame s to any frame t.

In particular, embodiments of the present invention are useful to, given a background object inside a reference frame of a video stream, replace the object without changing the foreground action across the video (as was shown in FIG. 2). Thus, embodiments of the present method and computer-implemented system efficiently (and taking into consideration temporal consistency) classify the pixels in a video as occluded, non-occluded and partially-occluded and provide the color and its amount needed for optimal rendering of each pixel, given a region as reference and the map of each frame to that region.

### 5. OCCLUSION PROCESSING BLOCK DIAGRAMS

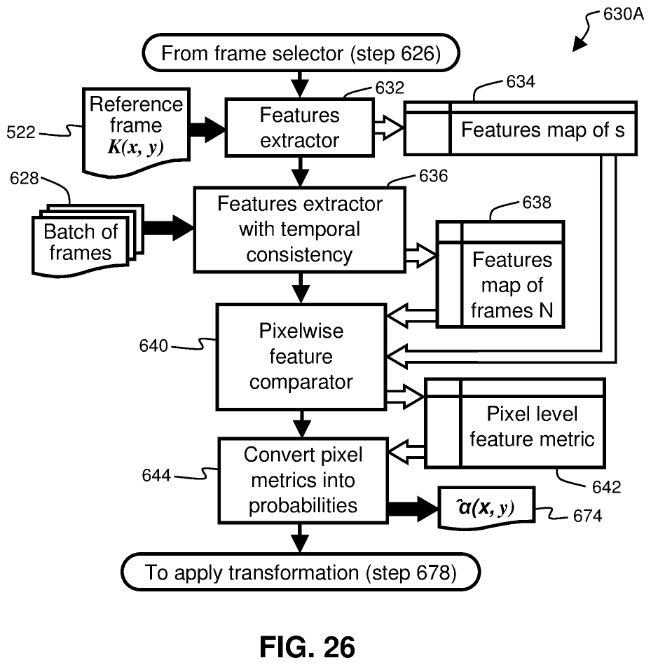

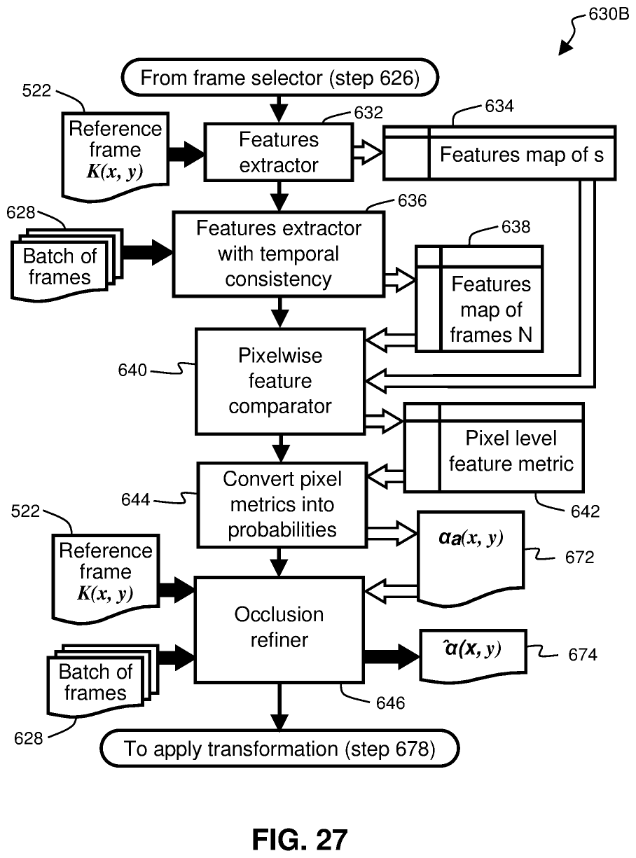

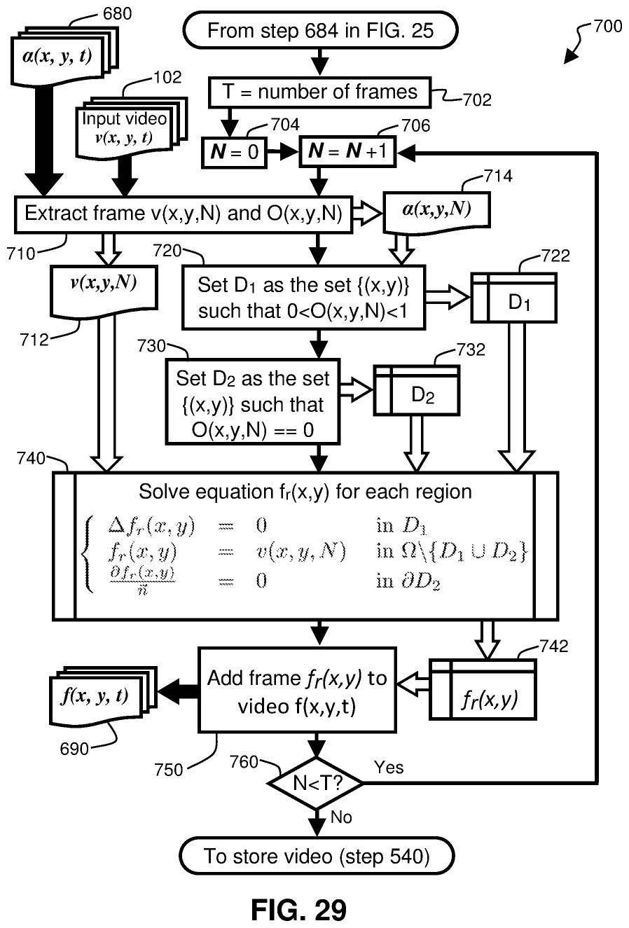

FIG. 24, FIG. 25, FIG. 26, FIG. 27, and FIG. 29 provide details of embodiments that can be used to perform the occlusion processing shown at 216 in FIG. 3 and FIG. 4. More specifically, FIG. 24 shows a block diagram of an in-video occlusion detection and foreground color estimation method at 500. This method 500 can also be called an occlusion processing method. In FIG. 24, the thin black arrows, from start to end, represent execution flow. The thick arrows represent data flow, with the white arrows showing data flow within the method 500 and the thick black arrows representing the flow of data into and out of the method 500. The main functional steps or modules that manage data in this occlusion detection and estimation method 500 comprise:
(a) A video selector 510 that manually or automatically (based on user settings 502) accesses a video storage device 504 to select a video, v(x,y,t) shown at 102.
(b) A reference frame selector 520 that manually or automatically selects a frame from v(x,y,t) 506 that will be used as a reference frame K(x,y), shown at 522. Note that the reference frame K(x,y) 522 is the same as the keyframe 522, shown in FIG. 6.
(c) A region selector 530 that manually or automatically marks a region ω (shown at 116) of the reference frame K(x,y) 522 in such a way that the pixels inside the region ω (shown at 116), are all non-occluded. One method for selecting the region ω 116 was shown and described with reference to FIG. 5A. For practical reasons, the region ω 116 is always a quadrilateral. For arbitrary shapes (e.g. circles, triangles, real objects) having a perimeter that cannot be mapped to a quadrilateral, these arbitrary images can be placed within a quadrilateral image that comprises a transparent layer for all pixels outside the perimeter of the shape. The same can be done for regions inside of the shape that are not part of the physical object.
(d) A classifier 600 that classifies each pixel (x,y) of each frame t in v(x,y,t) 102 as occluded, non-occluded, partially-occluded with respect to region ω 116 of the reference frame 522. The classifier 600 could be responsive to user settings 502. For instance, the number b corresponding to the number of frames for assuring temporal consistency. Notice that if b=1, then the problem is interpreted as frame-independent.
(e) The classifier 600 produces an occlusion function α(x, y, t) 680 and a color function ƒ(x,y,t) 690. In the store video step 540, these two functions (680 and 690) can be saved in an internal or external device 504 as two new videos with the same dimensions as the input video v(x,y,t) 102.

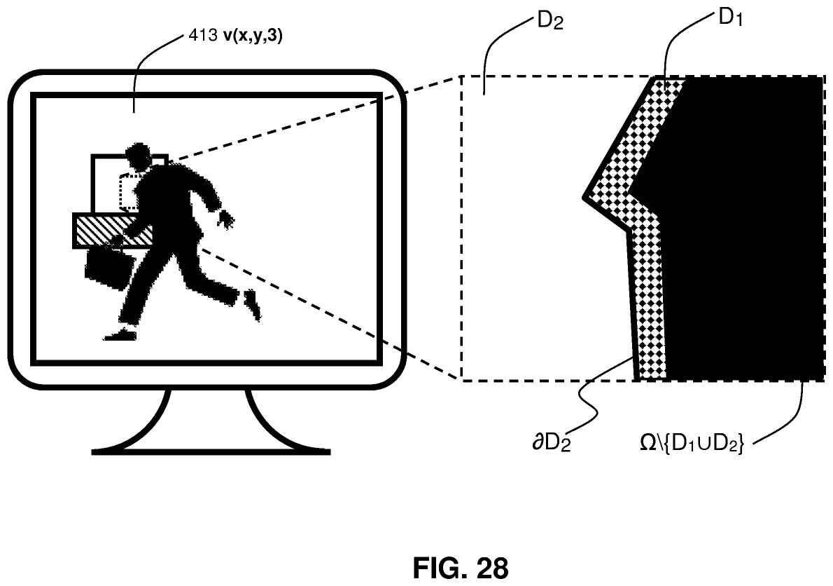

FIG. 25 details the classifier process shown at 600 in FIG. 24. The classifier process 600, could be used to perform the occlusion processing that was shown at 216 in FIG. 3 and FIG. 4. In FIG. 25, the thin black arrows from step 530 at the top to step 540 at the bottom, represent execution flow. The thick arrows represent data flow, with the white arrows showing data flow within the classifier process 600 and the thick black arrows representing the flow of data into and out of the classifier process 600. The classifier process shown at 600 in FIG. 25 comprises:
(a) A transformation map creator, shown at 608, that manually or automatically computes the set of transformations H(x,y,t), shown at 114, to register the reference frame K(x,y) 522 with the rest of the frames of the input video v(x, y, t) 102 according to some metric based on ω, which is the selected reference frame region 116. H(x,y,t) can also be referred to as a transformation map 114, and was shown and described with reference to FIG. 5A. The selected reference frame region ω, and one method for selecting it were shown and described with reference to FIG. 5A.
(b) Frame registration, which comprises a transformation map inverter 612 that generates an inverted transformation map 614, which is then applied to the input video 102 in the step shown at 616 to create a transformed video \hat{v}(x, y, t), shown at 618.
(c) A loop in which occlusions are applied to selected frames of the transformed video. This loop comprises a loop initialization 620, an incrementor 622, a frame selector 626 that receives a batch size (b) 624 and selects a batch of frames 628 from the transformed video 618, and a comparison process 630 that compares the batch of frames 628 to the reference frame 522 to generate a reference frame occlusion function \hat{α}(x, y) 674. The comparison process 630 will be further detailed in FIG. 26 and FIG. 27. After the comparison process 630, the final occlusion mask α(x,y,t) is computed from the reference frame occlusion function \hat{α}(x, y, t) in step 676 using the transformation map H(x,y,t) 114 to create the occlusion function α(x, y) 678 that was previously shown in FIG. 24. The occlusion function for a frame α(x, y) 678, is saved in step 682 to the occlusion layer 680, before the loop branches back to the incrementor 622 if there are more frames to compare, as shown at the decision 684.
(d) If there are no more frames to compare at 684, a propagate color process 700, further detailed with reference to FIG. 28 and FIG. 29, applies the occlusion function α(x, y, t) 680 to the input video 102 to produce the color function ƒ(x, y, t) 690 in FIG. 24. The propagation process 700 propagates color from areas where α(x, y, t)==1 to areas where 0<α(x, y, t)<1 to produce the color function ƒ(x,y,t).

FIG. 26 is a block diagram of one embodiment of a compare process 630A, shown at 630 in FIG. 25. FIG. 27 is an alternate embodiment of this compare process 630B. In FIG. 26 and FIG. 27, thin black arrows from step 626 at the top to step 678 at the bottom, represent execution flow. The thick arrows represent data flow, with the white arrows showing data flow within the compare process and the thick black arrows representing the flow of data into and out of the compare process. The compare process 630A in FIG. 26 can be divided in the following sequence:
(a) A features extractor 632 that extracts features for each pixel of the reference frame K(x,y) 522 to produce a features map of s, as shown at 634.
(b) A features extractor with temporal consistency 636 that extracts features for each pixel of a specific N frames from the batch of frames 628 and uses other frames in the batch of frames 628 to make this feature extraction temporally consistent to produce a features map of frames N 638.
(c) A pixelwise feature comparator 640 that compares the features map of reference frame s 634 to the features map of the frames N 638 to produce a pixel-level feature metric 642.
(d) A probability converter 644 that, classifies pixels as (i) non-occluded if the pixel level feature metric 642 from the feature comparator 640 indicates that the pixels are equal, (ii) occluded if the pixel level feature metric 642 from the feature comparator 640 indicates that the pixels are different, and (iii) partially occluded if the pixel level feature metric 642 from the feature comparator 640 indicates that the pixels is similar, but not equal. For partially-occluded pixels, the probability converter also quantifies a probability of occlusion. The probability converter then stores the resulting occlusion probabilities, as shown at 674.

The first sections of the alternate embodiment compare process 630B shown in FIG. 27 are identical to the compare process 630A shown in FIG. 26, but the alternate compare process 630B has an occlusion refiner 646, which can generate a more accurate occlusion mask. In the process 630B of FIG. 27, the probability converter 644 produces a preliminary occlusion probability for pixel (x,y) in the current frame and stores this in Oₐ(x,y), as shown at 672. The occlusion refiner 646 then uses the preliminary occlusion values 672, and perhaps the reference frame 522 and the batch of frames 628 to produce the occlusion probabilities 674 that will be used.

Referring to FIG. 26 and FIG. 27, the features extractors, 632 and 634, the comparator 640, and the occlusion refiner 646 can comprise deep learning methods. These processes can use the first layers from the VGG16 model, the VGG19 model, ResNet, etc., based on classical computer vision algorithms (color, mixture of gaussians, local histogram, edges, histogram of oriented gradients, etc.).

Referring to FIG. 28 and FIG. 29, color propagation, shown at 700 in FIG. 25, can be processed by solving the L² diffusion equation with homogeneous Neumann and Dirichlet boundary conditions. This method propagates colors from the region where α(x, y, t)=1 to the region where 0<α(x, y, t)<1. For a frame fr(x,y), let us define the L² diffusion problem as:

$$\{ \begin{matrix}Δ {f}_{r} ( x , y ) = 0 & in {D}_{1} \\ {f}_{r} ( x , y ) = v ( x , y , N ) & in Ω \backslash \{ {D}_{1} ⋃ {D}_{2} \} \\ \frac{\partial {f}_{r} ( x , y )}{\vec{n}} = 0 & in \partial {D}_{2}\end{matrix}$$

where (based on the regions shown in FIG. 28):
(a) fr(x, y) is the color at pixel (x, y) for frame N, i.e. fr is the unknown
(b) Δfr(x, y) is the Laplacian operator defined as the sum of the partial derivatives of fr

$$Δ {f}_{r} ( x , y ) = \frac{{\partial }^{2} {f}_{r} ( x , y )}{\partial {x}^{2}} + \frac{{\partial }^{2} {f}_{r} ( x , y )}{\partial {y}^{2}}$$

(c) D₁={(x,y)∈Ω:0<α(x, y, N)<1} is the region with unknown color
(d) D₂={(x,y)∈Ω:α(x, y, N)=0} is the region without occlusions
(e) Ω\{D₁∪D₂} is the complementary region to the union of D₁ and D₂, thus, the region of those pixels where are considered as totally foreground and therefor, the color is known.
(f) ∂D₂ is the boundary of region D₂, the pixels between regions where α(x, y, t)=0 and 0<α(x, y, t)<1
(g)

$$\frac{\partial {f}_{r} ( x , y )}{\vec{n}}$$

means the derivative of fr(x, y) with respect to the normal on the boundary ∂D₂.

Referring more specifically to what is shown in FIG. 28, D₁ is the region whose pixels have unknown pure foreground color. D₂ is the pure background region, i.e., with known color. Ω\{D₁∪D₂} is the pure foreground region, i.e., with known color. ∂D₂ is the boundary between regions D₁ and D₂, and because we stablish there homogeneous Neumann boundary conditions it acts as a barrier in the color diffusion process such a way colors from D₂ do not go into region D₁.

The idea behind solving this particular case of the L² diffusion equation is to spread the color from the pure foreground areas (α(x, y, N)=1) to areas where there is a mixture between background and foreground colors (0<α(x, y, t)<1) without taking into account pure background areas (α(x, y, N)=0). The last isolating effect from pure background areas is thanks to the homogeneous Neumann boundary conditions:

$$\frac{\partial {f}_{r} ( x , y )}{\vec{n}} = 0$$

The solution to the equation above can be found, but not restricted to, using gradient descent, or conjugate gradient descent, or multigrid methods with finite differences discretization. The above processing means should be performed by any multi-purpose computing device or devices for processing and managing data. In particular, these processing means may be implemented as one of more electronic computing devices including, without limitation, a desktop computer, a laptop computer, a network server and the like.

Referring more specifically to the color propagation process shown at 700 in FIG. 29, in this process thin black arrows from step 626 at the top to step 678 at the bottom, represent execution flow, the thick arrows represent data flow, with the white arrows showing data flow within the compare process and the thick black arrows representing the flow of data into and out of the color propagation process 700. The color propagation process 700 starts after the loop (step 684) in FIG. 25. The number of frames (identified by variable T) 702 are processed in a loop that starts by setting the loop counter (N) to zero 704 and then increments the counter at 706 until the loop has been run T times, as determined by the decision, shown at 760. In this loop video frames v(x,y,N) 712 and occlusion masks α(x,y,N) 714 are extracted 710 from the occlusion mask layers α(x,y,t) 680 that were developed previously and from the input video v(x,y,t) 102. Pixels (x,y) are put into D1 722 and D2 732 in steps 720 and 732 respectively. Then, in the process shown at 740 the equations described previously are solved for each pixel of frame N to produce fr(x, y) 742 for all pixels of frame N, and these values are stored as part of f(x,y,t) 680. Once this is complete, the loop moves to the next frame until all frames are processed, as shown at 760.

The methods and systems described herein could be performed by any multi-purpose computing device or devices for processing and managing data. In particular, these processing means may be implemented as one of more electronic computing devices including, without limitation, a desktop computer, a laptop computer, a network server and the like.

A number of variations and modifications of the disclosed embodiments can also be used. While the principles of the disclosure have been described above in connection with specific apparatuses and methods, it is to be clearly understood that this description is made only by way of example and not as limitation on the scope of the disclosure.

What is claimed is:

1. An automated method for generating modified digital video data comprising the steps of:
receiving input digital video data comprising a plurality of sequential digital video frames, wherein the sequential digital video frames comprise two-dimensional digital image data with each digital image having the same pixel row quantity and the same pixel column quantity;
receiving modification marker data wherein the modification marker data comprises two-dimensional marker image data;
transforming the marker image data to a normalized marker image data wherein:
the normalized marker image data comprises the same pixel row quantity and the same pixel column quantity as each digital image of the sequential digital video frames; and
the marker image data is transformed to the normalized marker image data by multiplying the marker image data by a marker normalization matrix;
calculating marker location transfer matrices for at least a sample of the plurality of sequential digital frames wherein each marker location transfer matrix:
is paired with one digital frame of the sample;
comprises a three row by three column matrix that, when multiplied by the normalized marker image data, produces a visual pattern that at least partially matches the comparable pixels of its paired digital frame;
calculating a confidence score for each pairing of a visual pattern and the comparable pixels of the paired frame in response to a measure of similarity of each visual pattern and the comparable pixels of the related frame;
selecting the digital video frame that is paired with the highest confidence score as a keyframe;
calculating a key transformation matrix wherein the key transformation matrix comprises a matrix transformation of the normalized marker image to the visual pattern in the keyframe;
calculating frame modification matrixes wherein each frame modification matrix, produces the marker location transfer matrix for a frame when the key transformation matrix is multiplied by the frame modification matrix;
generating occlusion information in response to:
the input digital video data;
the normalized marker image data;
modification marker data;
the key transformation matrix; and
the frame modification matrices; and
generating the modified digital video data in response to:
the key transformation matrix;
the frame modification matrices;
the occlusion information; and
modified visual content data wherein the modified visual content data comprises a two-dimensional image file.

2. The automated method for generating modified digital video data of claim 1 wherein:
the method further comprises the steps of:
generating color-correction information in response to:
the input digital video data;
the normalized marker image data;
modification marker data;
the key transformation matrix; and
the frame modification matrices;
generating shadow information in response to:
the input digital video data;
the normalized marker image data;
modification marker data;
the key transformation matrix; and
the frame modification matrices;
generating blur information in response to:
the input digital video data;
the normalized marker image data;
modification marker data;
the key transformation matrix; and
the frame modification matrices; and
the step of generating modified digital video data is further responsive to:
the color-correction information;
the shadow information; and
the blur information.
